(19) United States
(12) Patent Application Publication
(10) Pub. No.: US 2010/0299326 A1
(43) Pub. Date: Nov. 25, 2010

(54) Apparatuses, Methods and Systems For A Forum Ferreting System

(76) Inventor: Scott Germaise, Jersey City, NJ (US)

Correspondence Address: CHADBOURNE & PARKE LLP, 30 ROCKEFELLER PLAZA, NEW YORK, NY, 10112, US

(21) Appl. No.: 12/739,373

(22) PCT Filed: Oct. 24, 2008
(86) PCT No.: PCT/US08/81176

§ 371 Date: Jun. 30, 2010

Related U.S. Application Data
(60) Provisional application No. 60/983,074, filed on Oct. 26, 2007.

(51) Int. Cl. G06F 17/30

(52) U.S. Cl. 707/728; 707/741; 707/781; 707/769; 707/754; 707/E17.002; 707/E17.059; 707/E17.014

(57) ABSTRACT

This disclosure details apparatuses, systems and methods for a forum ferreting system. Various implementations of the system may be configured to meet the needs of a variety of users. In one embodiment, the system may be configured to provide users with a variety of search options, including popularity and/or relevance. Users may also be provided with customized groupings or favorites via a customized interface. Such interfaces may allow users to apply search tools, save searches, apply filters, provide feedback, and/or the like. Additionally, in some embodiments, the forum ferreting system may facilitate contextual advertising.

### RELATED APPLICATIONS

Applicant hereby claims priority under 35 USC §119(e) to U.S. Provisional Patent Application Ser. No. 60/983,074 filed Oct. 26, 2007, entitled “APPARATUSES, METHODS AND SYSTEMS FOR FORUM SEARCH,” attorney docket no. 17253-019PV. The entire contents of the aforementioned application is herein expressly incorporated by reference.

### FIELD

The present disclosure generally discusses apparatuses, methods and systems for data searching. More specifically, the present disclosure discusses aspects of providing a system that facilitates search and navigation of forum data.

### BACKGROUND

Current computer-based data searching techniques, such as Internet search engines, allow for the searching of web pages and documents. Users enter search terms or queries and the search engines return web pages or documents that contain the entered terms or queries.

### SUMMARY

This disclosure discusses apparatuses, systems and methods for a forum ferreting system (hereafter “FFS”) for searching and navigating forum information. The disclosed FFS provides a search collection of data for users to seek out items of interest across forums, including electronic bulletin boards, web forums, message boards, discussion boards, electronic discussion groups, discussion forums, and the like. There are several million forum installations worldwide, and in one embodiment, the disclosed FFS may be directed to the following general forum types: forums in top standard software formats, forums within top standardized services, and custom forums.

The FFS provides effective, efficient and flexible forum ferreting and searching. As such, in some embodiments, the FFS may provide a valuable service to a niche market of web searchers. In an implementation, the FFS may be configured to meet the needs of a variety of users. For example, in one embodiment, the FFS may be configured to provide a deeply contextually keyword rich environment to carry contextual advertising.

### BRIEF DESCRIPTION OF THE DRAWINGS

The accompanying appendices and/or drawings illustrate various non-limiting, example, inventive aspects in accordance with the present disclosure:

FIG. 1 provides a high-level overview diagram for an embodiment of the FFS;

FIGS. 2A-2C provide a logic flow diagram illustrating aspects of the forum ferreting process for an embodiment of the FFS;

FIG. 3 provides a logic flow diagram illustrating a forum evaluation process for an embodiment of the FFS;

FIG. 4 provides an overview flow diagram illustrating additional aspects of one embodiment of the FFS;

FIG. 5 provides a flow diagram illustrating aspects of filtering for one embodiment of the FFS;

FIG. 6A provides a logic flow diagram illustrating aspects of an embodiment of the FFS;

FIG. 6B provides an overview diagram illustrating user access aspects for an embodiment of the FFS;

FIGS. 7A-7B illustrates example landing page user interfaces for embodiments of the FFS;

FIG. 8 illustrates an example homepage interface for one embodiment of the FFS;

FIG. 9A illustrates an example forum search results page interface for one embodiment of the FFS;

FIG. 9B provides an example forum search results page interface for an embodiment of the FFS;

FIG. 9C-9E illustrates details for forum search information interfaces for some embodiments of the FFS;

FIG. 10A provides detail for a forum search results taxonomy selection interface for one embodiment of the FFS;

FIG. 10B provides detail for forum search filter/navigator interface for an embodiment of the FFS;

FIG. 10C provides detail for forum search keyword and date scoping interfaces for one embodiment of the FFS;

FIG. 10D provides detail for interface aspects of another embodiment of the FFS;

FIG. 11 provides an example warning/filtering interface for an embodiment of the FFS;

FIGS. 12A and 12C illustrate example user interfaces for embodiments of the FFS;

FIG. 12B provides an example site map interface for an embodiment of the FFS;

FIGS. 13A-13F provide example screen shots illustrating aspects of user sign-up for an embodiment of the FFS;

FIG. 14A provides an example screenshot illustrating aspects of the FFS for saving forum search;

FIG. 14B provides an example alert interface for an implementation of the FFS;

FIGS. 14C-14D provides example screenshots illustrating aspects of user engagement interfaces for embodiments of the FFS;

FIGS. 15A-15C provide example taxonomy interfaces embodiments of the FFS;

FIG. 16 provides an example setting/preferences interface for an embodiment of the FFS;

FIGS. 17A-17C provide example user favorites management interfaces for an embodiment of the FFS;

FIG. 18 provides an example user account modification interface for an embodiment of the FFS;

FIG. 19A illustrates a example newsletter template for an embodiment of the FFS;

FIGS. 19B-F provide example FFS-associated newsletter user-management interfaces for an embodiment of FFS;

FIGS. 20A-20G provide example interfaces illustrating aspects of FFS widgets and tools for some embodiments of the FFS;

FIG. 21 provides an example toolbar illustrating some of the features for an embodiment of the FFS;

FIG. 22 provides an example feed interface for an embodiment of the FFS;

FIG. 23 provides an example user interface for receiving user submissions for an embodiment of the FFS;

FIG. 24A provides an example forum owner forum submission interface for an embodiment of the FFS;

FIGS. 24B-24H provide additional example interfaces for embodiments of the FFS; and

FIG. 25 is of a block diagram illustrating embodiments of an FFS controller.

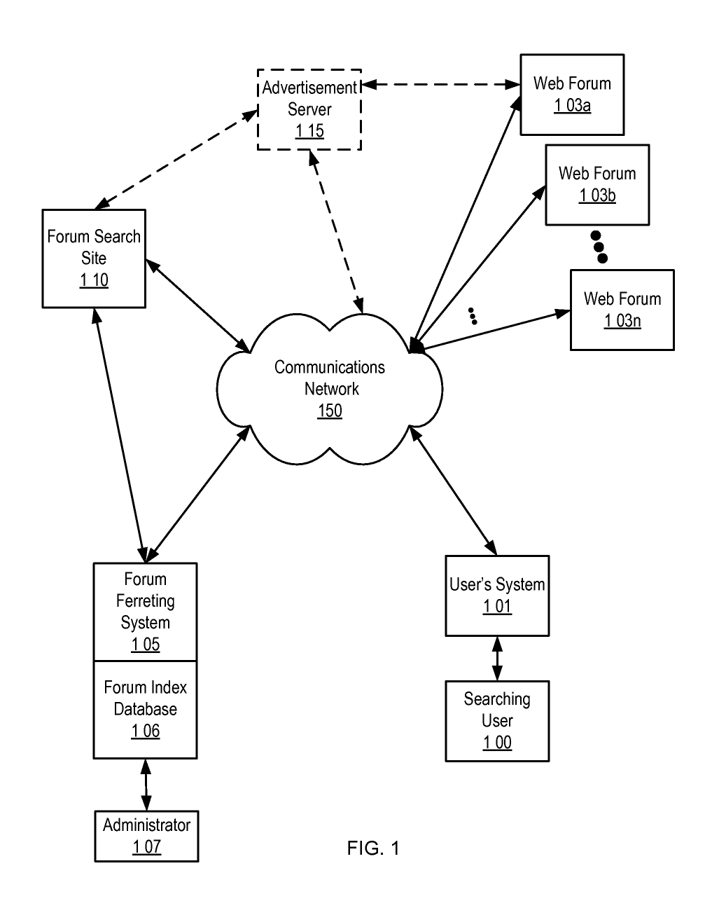

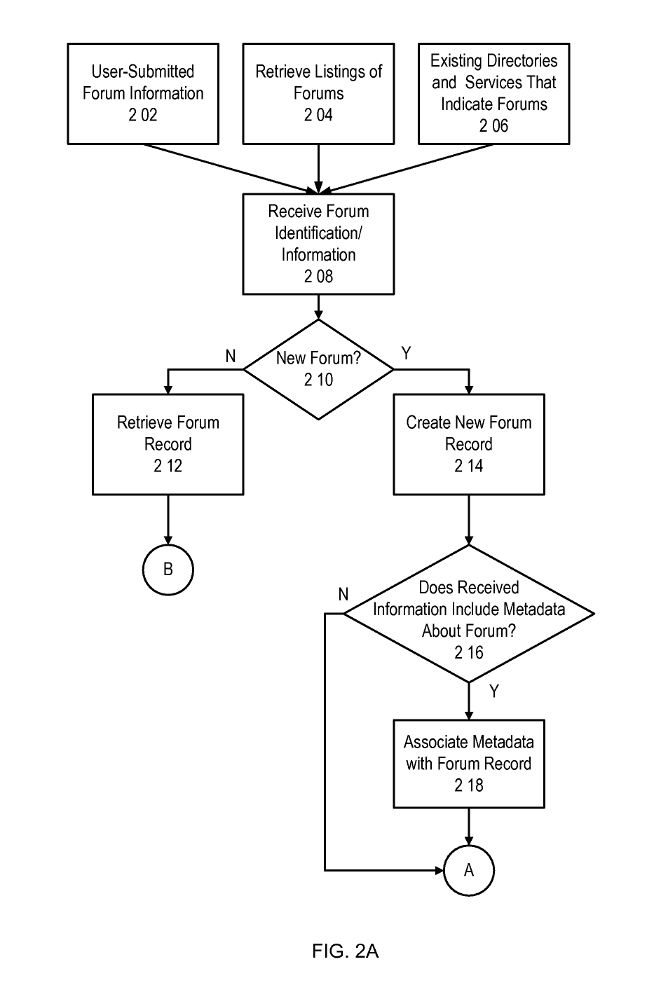

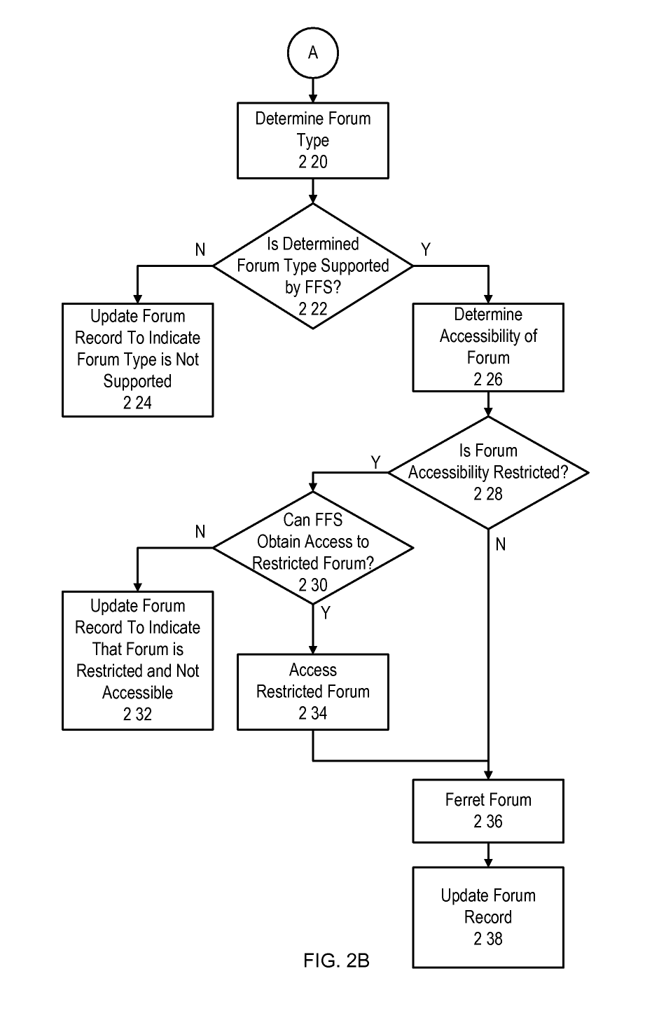

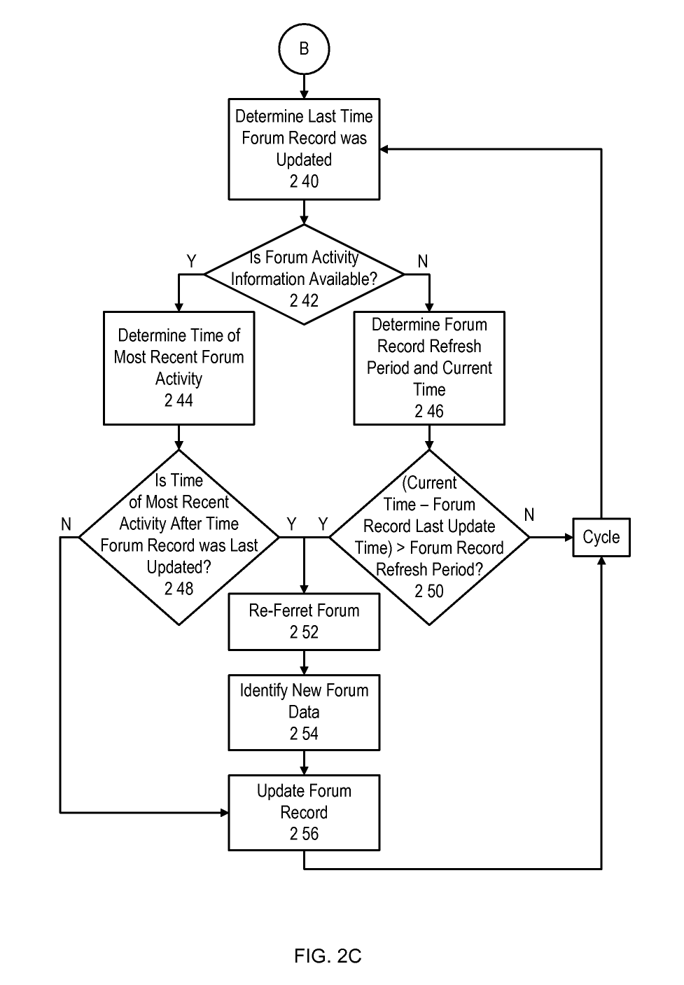

The leading number of each reference number within the drawings indicates the figure in which that reference number is introduced and/or detailed. As such, a detailed discussion of reference number 101 would be found and/or introduced in FIG. 1. Reference number 202 is introduced in FIG. 2, etc.

### DETAILED DESCRIPTION

The present disclosure discusses aspects of implementations of a forum ferreting system and functionality associated with a variety of system components. It is to be understood that in a variety of implementations, the forum ferreting system (FFS) provides significant flexibility. For example, the FFS may be configured to provide users with a variety of search options, including popularity and/or relevance. Users may also be provided with customized groupings or favorites, which in a further embodiment, may be provided to the user via a customized interface. Such interfaces may allow user to apply search tools, save searches, apply filters, provide feedback, and/or the like. Additionally, in some embodiments, the FFS may facilitate contextual advertising.

The disclosed FFS provides a search collection of data for users to seek out items of interest across forums, including electronic bulletin boards, web forums, message boards, discussion boards, electronic discussion groups, discussion forums, and the like. In addition to providing forum search and navigation, the FFS may facilitate and/or perform community discovery, community flagging, and/or community exclusion. Community discovery may include forum indexing via existing lists, user submission, ferreting engine discovery, web index mining, and/or additional methods. Community flagging and/or exclusion may include user flagging, black list exclusion, red list exclusion, offensive list exclusion, opt out list exclusion, special list exclusion, robot exclusion and/or other flagging or exclusion methods. There are several million forum installations worldwide, and in one embodiment, the disclosed FFS may be directed to the following general forum types: forums in top standard software formats, forums within top standardized services, and custom forums.

FIG. 1 provides a high-level overview diagram illustrating entities and associations/interactions for an implementation of one embodiment of the FFS. The FFS 105, which may include and/or be in communication with a forum index database 106, may have a number of connections, either directly or through a communications network 150 (e.g., the Internet). The FFS 105 and/or forum index database 106 may be configured to allow an administrator 107 or other authorized user to monitor and/or manage the functioning of the system and/or database. The FFS 105 may access or otherwise communicate with numerous web forums 103a-103n and/or like systems in order to ferret and store and/or index forum information (i.e., in the forum index database 106). In some embodiments, the FFS 105 provides access to this forum information via a forum search site 110. In other embodiments, the FFS 105 may additionally or alternatively provide access to ferreted forum via one or more of the ferreted web forums 103a-103n. For example, in one embodiment, a web forum may wish to provide forum-specific search capabilities. The FFS may provide access to the capabilities and/or tools of the FFS to users of the web forum, e.g., via a search box or other interface on the web forum's site or page(s).

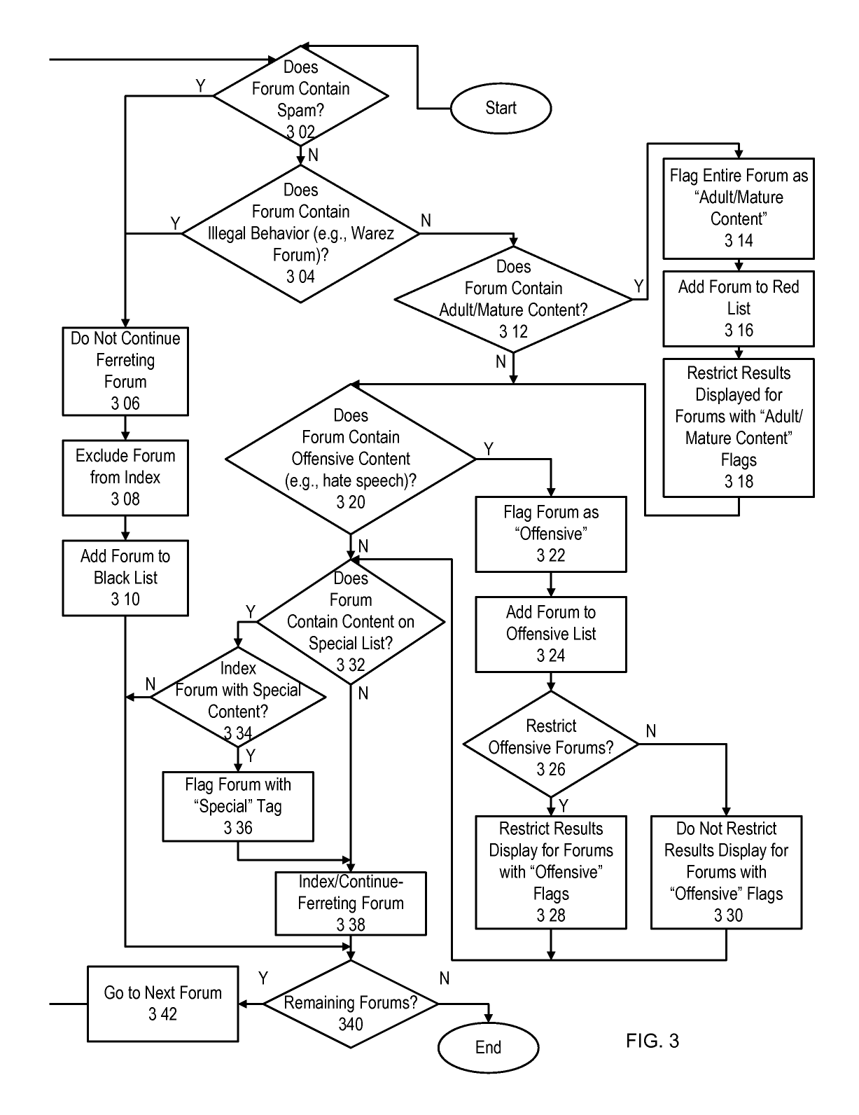

In a further embodiment, an advertisement server 115 may be utilized to provide tailored advertisements to searching users. For example, in one embodiment, as forums 103a-103n are ferreted by the FFS 105, ads or advertisement-indicia may be associated with particular forums and/or forum sub data (e.g., posts). When a searching user 100, via their system 101, enters search terms or logic (e.g., into an interface on the forum search site 110), the FFS may return the forum search results, along with ads from the advertisement server 115, wherein the ads provided to the user 100 are ads that are associated with the top forum search results. In another embodiment, advertisements may be selected based on the forum search logic or selections entered by the user 100. In yet another embodiment, advertisements may be provided based on the forum from which the top search result or results were originally ferreted from. For example, if a searching user entered search criteria that resulted in forum data from a particular music forum, the advertisement may be music specific, and may, in some implementations, even be tailored to the type or genre of music associated with the forum. In a further embodiment, advertising may additionally or alternatively be influenced by flags and/or tags that are associated with a forum and/or related results, as described in greater detail in FIG. 3.

FIGS. 2A-2C provide a logic flow diagram illustrating aspects of the forum (or like message system) ferreting process for an embodiment of the FFS. To initiate the ferreting process, in one implementation the FFS may receive 208 user-submitted forum information 202 and/or may retrieve a listing of forums 204. For example, in one embodiment, users may add forums to a ferreting target list, and such user submissions may include forum metadata. A listing or listings of forums may, in some implementations, be provided by internal system users. The FFS may alternatively or additionally utilize existing directories and services that indicate forums 206. In a further embodiment, the ferreter may be configured to recognize indications of forums and forum data from non-forum information, and may utilize this ability to dynamically seek out forums and store information. For example, the ferreter may be configured to identify forum-type information and once forum-type information has been discovered, the FFS may add the forum URL to a list of forums to be more thoroughly ferreted. Once the FFS has received the forum identification/information, a determination is made as to whether the forum is a new forum 210.

If the forum is a new forum 210, the FFS creates a new forum record 212. The FFS determines if the received information includes forum metadata 216 and if so, associates the metadata with the new forum record 218. The FFS may then determine the forum type 220. Forum types may include, but are not limited to: standard (i.e., the forum utilizes standard forum software such as open source and/or commercial software), normalized (e.g., ezboard, Delphi/Prosper, etc.), and proprietary (e.g., linear or threaded “home grown” versions). The FFS determines if the forum type is currently supported 222, and if not, updates the forum record to indicate that the forum is of a type that is not currently supported. In some embodiments, forums or forum types that are determined to be currently unsupported may be flagged or noted, and support for that forum or forum type may be developed. For example, if a popular forum were determined to be proprietary and not currently supported, the FFS may be configured to work with the forum to develop the necessary information to support the forum type. Alternatively, forums that are not currently supported may be notified by the FFS, and may be able to provide information to and/or coordinate with the FFS to get develop support for the forum.

If the forum is determined to be of a type currently supported 222, the FFS determines the accessibility of the forum 226. If the forum is access restricted 228 (e.g., login and password required), the FFS determines if it can obtain access to the restricted forum 230. In some embodiments, depending on the forum, obtaining access may require registration, fee payment, administrative approval, and/or the like. If the FFS is unable to obtain access to the forum 230, the forum record is updated to indicate that forum is restricted and not accessible 232. In one embodiment, the FFS may contact the forum provider or host to attempt to obtain access. The FFS may be configured to provide secure forum ferreting and forum search. For example, a private forum owner or administrator may want provide the FFS forum search tools to registered users of the private forum but may also want to restrict access to the search results to those same users. The FFS may be equipped to provide such services, for example, via a search interface in the private forum and restricted access to ferreted information. In some embodiments, the FFS may be configured to provide partial results from private forums to public users, with the proper approvals. For example, a certain pay forum may want to allow non-paying (or non-registered) users to get partial or truncated search results from the pay forum to encourage users to pay (or register). The FFS may also be configured to process forums that have both public and private sub-areas. The FFS may then ferret the forum 236 and update the forum record 238.

If the forum is a known forum 210, the FFS may retrieve the forum record 212 and determined the last time that the record was updated 240. The FFS may then determine if forum activity information (e.g., new posts, topics, threads, etc.) is available 242 and if so, determines the time of the most recent forum activity. If the most recent forum activity is before the last time the forum record was updated 248, the forum record is updated to reflect this. If the most recent forum activity is after the last time the forum record was updated 248, the forum is re-ferreted 252, new forum data is identified 254 and the forum record is updated 256.

If the forum activity information is not available 242, the FFS may determine the indicated forum record refresh period and the current time 246. Different forums may have different refresh periods, for example, a current news forum with high user traffic may have a short refresh period while a scholarly forum with fewer users may have a longer refresh period. In one embodiment, forums may have different refresh tempos, and may be grouped into tempo tiers. For example, there may be a standard tempo tier, which in some implementations may dynamically modify the tempo to account for changing post frequencies and/or volumes and/or to efficiently utilize FFS resources. Other tiers may include an administrator tier, in which a FFS administrator sets the refresh tempo, and/or a partner/client tier, in which the partner or client (e.g., forum host) sets the refresh tempo. Additionally, in some embodiments, forums may request or pay-for control of refresh periods. The FFS determines if the difference between the current time and last update time is greater than the indicated refresh period 250, and if so, re-ferrets the forum 252, identifies new forum information 254 and updates the forum record 256.

FIG. 3 provides a logic flow illustrating a forum and/or site evaluation process for an embodiment of the FFS. The FFS may start the evaluation for a forum/site once at least some relevant data (e.g., forum data) has been collected and/or during the ferreting of the forum. The FFS may determine if the forum contains spam 302 or illegal behavior 304 (such as software piracy), and if the forum contains either or both, the FFS may stop ferreting the forum 306 (if still ferreting), may exclude the forum from the forum index 308, and may add the forum to a forum “black list” 310. In some embodiments, a forum black list is a list of forum which will not be ferreted and/or indexed by the FFS. In one implementation, authorized users (e.g., internal administrators and the like) may add, delete and/or modify entries in the forum black list. In a further embodiment, the spam and/or behavior analysis may utilize thresholds or tiers such that if a site has, for example, one or two spam or illegal incidents, the FFS may notify the site, and may continue to ferret the site, while if a forum has many pieces of spam or appears dedicated to illegal behavior (based on exceeding the threshold), the FFS may stop ferreting the forum. The FFS determines if there are remaining forums 340, and if so, goes on to the next forum 342.

If the FFS determines that the forum does not contain 302 and illegal behavior 304, the FFS may then determine if the forum contains adult and/or mature content 312 and if so, flags the forum as having adult and/or mature content. The forum may then be added to a forum “red list” of similar sites 316. The FFS may then restrict results displayed for forums that are flagged as “adult” and/or “mature” 318. In some embodiments, entire forums may be flagged, while in other embodiments, the flagging may be applied to sub-forums, topics, and/or threads. In some implementations, a warning may be provided before flagged results are shown, while in another embodiment, the FFS may require a searching user to log in or otherwise verify their age or like credentials before the flagged forum search results are provided.

The FFS may also determine if the forum contains offensive content 320 (e.g., hate speech or the like), and if so, flag the forum as “offensive” 322 and may add the forum to an offensive list 324. Depending on the embodiment, different standards of what is offensive may apply, and multiple flags may be utilized to reflect this. For example, what may be offensive in one country may not meet the threshold for offensiveness in another country, and the flags applied to the forum may reflect this. In some embodiments, if the FFS restricts offensive forums 326, the FFS may restrict results displayed for forums with “offensive” flags 328. Otherwise, the FFS does not restrict results from forums with “offensive” flags 330.

In some embodiments, the FFS may have a list of sensitive of “special” content that may need to be filtered, flagged, and/or not displayed. In one embodiment, the non-display of material deemed to be sensitive or “special” may be based on the searching user's location. In such embodiments, the FFS determines if the forum contains content on the “special list” 332, and if it does, determines whether ferreting and/or indexing the forum is allowed 334. If ferreting and/or indexing is allowed, the forum may be flagged with one or more “special” tags 336, which may contain additional detail about the potential issue and/or content, and the indexing/ferreting of the forum is continued 338.

In some embodiments, the FFS may be configured to recognize exclusion indicators on forums. Exclusion indicators may allow a forum host or other interested party to request that the forum and/or associated data not be ferreted and/or indexed. The FFS may note the presence of such indicators and add the associated forums (and/or sub-forums, threads, etc.) to an exclusion list. Similarly, forum administrators and/or the like may communicate with the FFS to request that certain forums not be ferreted, and the FFS may add indicated forums to an exclusion list. Once the acceptability of ferreting/indexing of the forum has been determined, and appropriate flags and/or tags have been applied, the FFS continues the indexing/ferreting 338. Once completed, the FFS determines if there are forums remaining 340, and if so, goes on to the next forum 342.

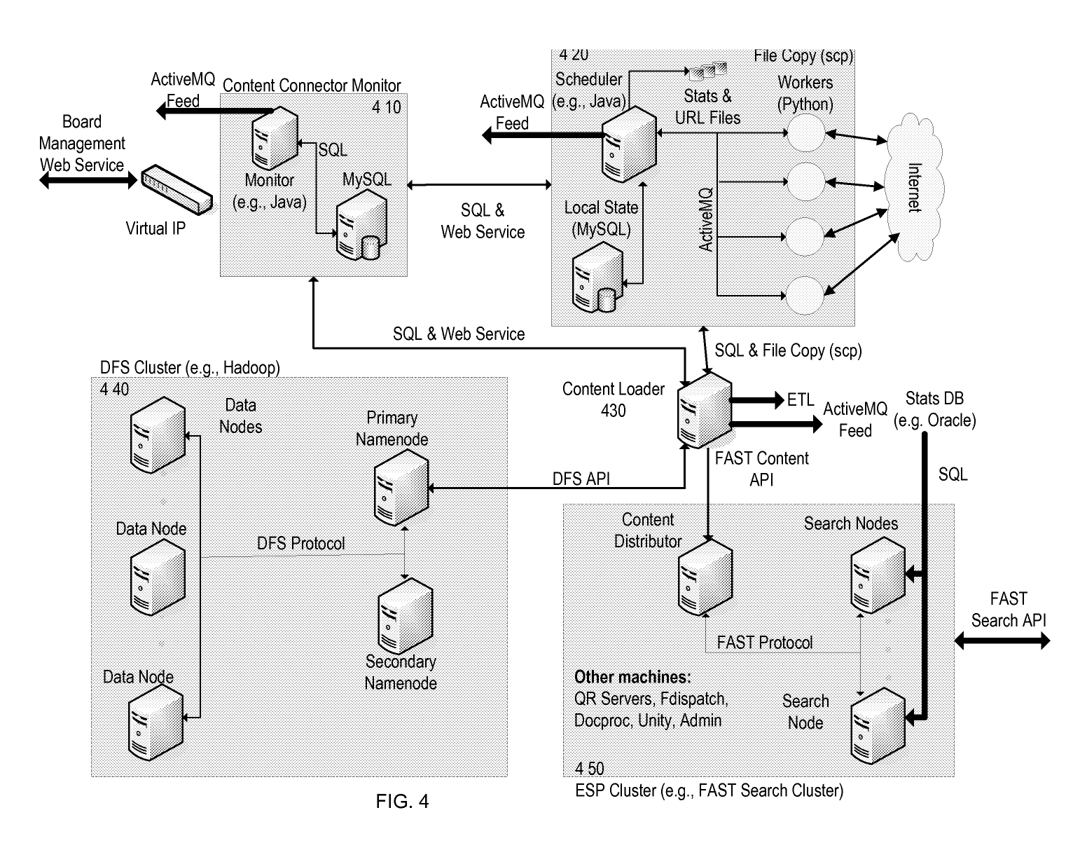

FIG. 4 provides an overview flow diagram illustrating aspects of one embodiment of the FFS. In this embodiment, the FFS retrieves data/content from various boards, stores data/content in long-term storage, indexes data/content and/or delivers search results to a front-end. In one implementation, the indexing of data/content is done via a FAST ESP engine. In some embodiments, the FFS may include a number of sub-systems, including an FFS content monitor 410, a content ferreter 420, a content loader 430, a distributed file system (DFS) cluster 440, and/or an enterprise search platform (ESP) cluster 450, for example, a FAST ESP cluster.

In one implementation, the content monitor 410 exposes an interface to allow a board management tool and/or service to start or stop processing a board, change the board hit rate, adjust the ferreting frequency, and/or the like. This data may then be stored (e.g., stored in a local MySQL instance running on the content monitor 410). In some implementations, this data may be referred to as the central config database. The content monitor may also send commands to the content ferreter 420 and/or associated systems. The content monitor may also send response messages back to one or more board management tools (e.g., using ActiveMQ).

In one embodiment, the content ferreter 420 may be configured to communicate with a MySQL instance running on the content monitor 410 to get the list of boards assigned to it. The content ferreter 420 may then retrieve content from the boards and may create board, thread and post stats files. In some embodiments, the text content of the posts may be stored in a file on one or more local file systems. The content ferreter 420 may also run a MySQL instance in which the state of each board is stored.

In one implementation, the content ferreter 420 includes the following two modules that communicate (e.g., via ActiveMQ queue): a scheduler process (e.g., written in Java) and a worker process (e.g., written in Python). The scheduler may fetch boards from a central config database, report health status to a health manager (e.g., using an ActiveMQ interface), produce jobs for the worker processes at fixed intervals, process job status replies from the workers, and/or the like. The scheduler may store its local state in a MySQL server instance or the like.

In one embodiment, one or more worker processes may download and parse content from external boards. In some implementations, while processing content, the worker processes may generate thread stats, post stats and/or post content, any or all of which may be stored in files on a local file system. These files may be rotated periodically (for example, on the hour) and may be processed or consumed by the content loader 430. In one embodiment, the workers store board state data in a local MySQL instance.

In one embodiment, the content ferreter 420 interprets the content of a page and may generate structured content from unstructured content. In order to accomplish this, the content ferreter 420 may be configured to recognize the HTML or like structure of various sub-sections of a forum and recognize various metadata. For example, one type of bulletin board may be a vBulletin board, which includes forums, sub-forums, threads, and posts, and the content ferreter 420 may be configured to recognize and distinguish each of these.

In one embodiment, the input to the content ferreter is the start page of a message board and the type of the board (e.g., vBulletin, phpBB, etc.). Using this information, the content ferreter may parse the start page to determine the number of forums and their links. Any other links on this page may be discarded, or noted for further analysis. After a specified delay, the content ferreter may then visit forum URLs and determine if there are any sub-forums. In one implementation, this is an iterative process, and at the end of the process, the content ferreter has determined all the forums and sub-forums on the message board.

The content ferreter may then look at each forum page and extracts some or all URLs that fit the pattern of a thread URL. Again, any other URLs may be discarded or noted for further analysis. During this process, the content ferreter also gets the number of threads, and may also determine the number of views of particular threads. This information may be used to determine whether the content ferreter would need to re-ferret a particular thread and also used to figure out the ferreting priority of a particular thread.

If there are multiple pages of threads in a forum, the content ferreter may jump to the next page and continue retrieving or fetching the thread information. In one embodiment, instead of following the URL embedded in the HTML of the page, the content ferreter crafts this URL using board configuration information. For example, when new threads are added to a forum that was already ferreted, the content ferreter may skip pages it has already seen in order to reduce load on the board.

Once all the necessary thread URLs have been determined, the content ferreter may visit each one of them (in one implementation, for example, starting with the latest thread) and pull in posts that have been added to the thread. In one implementation, rather than following the URL embedded in the HTML of the page, the content ferreter crafts this URL using board configuration information. Thus, if there are more pages of posts for a given thread, the content ferreter may iterate through all pages and pulls in the posts. In one embodiment, as the final output of the ferreting process, files including board stats, thread stats, post stats, post content, post URLs and/or the like may be generated for each board.

In some embodiments, every time stats and content are generated, they may be stored in a directory to ensure that data for every hour is stored in one central location. For example, in one embodiment the directory may have the following format:
/panda/data/BOARD/YYYMMDDHH00/
   The below is an example directory structure for one embodiment:

| | |
|---|---|
| User that all processes run under | panda |
| Root directory ($PANDA_ROOT) | /home/panda/ |
| Executables | /home/panda/bin/ |
| Libraries | /home/panda/lib/ |
| Configuration files | /home/panda/etc/ |
| Output directory | /home/panda/data/ |
| Log files | /home/panda/logs/ |

### Board Stats

In some embodiments, a process on the content ferreter runs periodically (e.g., every night) to visit each board and get board stats. In one implementation, this process may writes these stats to a file with the example format provided below:
$PANDA_ROOT/BOARD_ID/TIMESTAMP/bstats.dat
   For such an implementation, the below provides an explanation of the fields in the above filename:

| | |
|---|---|
| BOARD_ID | Id of the board (integer) |
| TIMESTAMP | YEARMONTHDAYHOURMIN (where MIN will |
| | always be 00). For example, 200708211300 |

The file may contain (all in one line):
BOARD_ID<tab>THREADS<tab>POSTS<tab>MEMBERS<nl>
   With the following explanation of the fields in the content:

| | |
|---|---|
| BOARD_ID | Id of the board (integer) |
| THREADS | Total number of threads (integer) |
| POSTS | Total number of posts (integer) |
| MEMBERS | Total number of members (integer) |

### Thread Stats

The worker may generate thread stats every time it encounters a forum page that contains new or updated threads. In one implementation, for example, this may be stored in the file:
$PANDA_ROOT/BOARD_ID/TIMESTAMP/tstats.dat
   With the following explanation of the fields in the example filename:

| | |
|---|---|
| BOARD_ID | Id of the board (integer) |
| TIMESTAMP | YEARMONTHDAYHOURMIN (where MIN will |
| | always be 00). For example, 200708211300 |

This file may contain (all in one line):
BOARD_ID<tab>THREAD_ID<tab>REPLIES<tab>VIEWS<nl>
   With the following explanation of the fields in the content:

| | |
|---|---|
| BOARD_ID | Id of the board (integer) |
| THREAD_ID | Id of the thread (integer) |
| REPLIES | Total number of replies (integer) |
| VIEWS | Total number of views (integer) |

### Post Stats

In one embodiment, when the content ferreter finds a new post, it may write a line into the post stats file, an example of which is provided below:
$PANDA_ROOT/BOARD_ID/TIMESTAMP/pstats.dat
   With the following explanation of the fields in the filename:

| | |
|---|---|
| BOARD_ID | Id of the board (integer) |
| TIMESTAMP | YEARMONTHDAYHOURMIN (where MIN will |
| | always be 00). For example, 200708211300 |

Fields in this file may be binary with no delimiters for the fields, for example:
TIMESTAMPBOARD_IDTHREAD_ID<nl>
   With the following explanation of the fields in the content:

| | |
|---|---|
| TIMESTAMP | Unix timestamp; seconds since epoch (4 bytes) |
| BOARD_ID | Id of the board (4 bytes) |
| THREAD_ID | Id of the thread (4 bytes) |

### Post Content

In some embodiments, the content ferreter may extract text content of posts that it finds and stores the extracted text content in a file on the local file system. For example, in one implementation, for every new post that the ferreting engine encounters, a file in the following format is appended to:
$PANDA_ROOT/BOARD_ID/TIMESTAMP/posts.txt
   With the following explanation of the fields in the filename:

| | |
|---|---|
| BOARD_ID | Id of the board (integer) |
| TIMESTAMP | YEARMONTHDAYHOURMIN (where MIN will |
| | always be 00). For example, 200708211300 |

This file may contain (all in one line):
BOARD_ID<tab>FORUM_ID<tab>THREAD_ID<tab>POST_KEY<tab>HAS_IMAGES<tab>HAS_AUDIO<tab>HAS_VIDEOS<tab>TIMESTAMP<tab>AUTHOR<tab>TITLE<tab>BODY<nl>
   With the following explanation of the fields in the content:

| | |
|---|---|
| BOARD_ID | Id of the board (integer) |
| FORUM_ID | Id of the forum (integer) |
| THREAD_ID | Id of the thread (integer) |
| POST_KEY | External id of the post (string) |
| HAS_IMAGES | Zero or one depending on whether the post has images; see |
| | below (integer) |
| HAS_AUDIO | Zero or one depending on whether the post has audio files; see |
| | below (integer) |
| HAS_VIDEOS | Zero or one depending on whether the post has video files; see |
| | below (integer) |
| TIMESTAMP | UNIX timestamp of the post; seconds since epoch (integer) |
| AUTHOR | Author of the post (string) |
| TITLE | Title of the post; if no title, this is empty (integer) |
| BODY | Text content of the post; convert tabs and multiple spaces to one space |
| | (integer) |

In one embodiment, the content ferreter may look at the extension of the URLs to determine whether it is a video file, audio file, image file, etc. Below is non-limiting example list of extensions that may be supported by one embodiment (and which may be in a config file):

| | |
|---|---|
| Image Types | 3dm, 3dmf, ai, bmp, drw, dxf, eps, gif, indd, jpeg, jpg, mng, pct, png, |
| | ps, psd, psp, qxd, qxp, svg, tif |
| Audio Types | aac, aif, iff, m3u, m4a, m4b, m4p, mid, midi, mp3, mpa, ra, ram, wav, wma |
| Video Types | 3gp, asf, asx, avi, divx, dv, dvr-ms, |
| | flv, gvi, gvp, ifo, m1v, m2v, m4e, m4u, m4v, mkv, moov, mov, |
| | movie, mp4, mpe, mpeg, mpg, qt, rm, swf, tivo, ts, vob, wmv, wmx |

Some embodiments may also examine URLs to determine if it is a video or other media type, for example, youtube or the like.

### Post URLs

In one embodiment, links to images, audio files, videos and the like may be extracted from post, and in one implementation, stored in a file with the following format:
$PANDA_ROOT/BOARD_ID/TIMESTAMP/urls.dat
   With the following explanation of the fields in the filename:

| | |
|---|---|
| BOARD_ID | Id of the board (integer) |
| TIMESTAMP | YEARMONTHDAYHOURMIN (where MIN will |
| | always be 00). For example, 200708211300 |

This file may contain (all in one line):
BOARD_ID<tab>THREAD_ID<tab>POST_KEY<tab>URL_TITLE<tab>URL<tab>TIM ESTAMP<nl>
   With the following explanation of the fields in the content:

| | |
|---|---|
| BOARD_ID | Id of the board (integer) |
| THREAD_ID | Id of the thread (integer) |
| POST_KEY | External id of the post (string) |
| URL_TITLE | Title of the URL link (string) |
| URL | URL (string) |
| TIMESTAMP | UNIX timestamp of the post; seconds since epoch |
| | (integer) |

### Content Loader

In one embodiment, the content loader 430 may periodically move the stats data and/or post content generated by the content ferreter 420 machines to a local file system. Stats data files may then be concatenated into one single file and uploaded to one or more extract transform load (ETL) machines or modules. Upon successful upload, the files may be deleted from the local storage. The content loader 430 may upload the post content data into the DFS. Periodically, these files are pulled from the DFS 440 and sent to the ESP 450 and/or content distributor for indexing.

The content loader 430 may also respond to commands from the content monitor 410 to delete a board from the index, re-index board information, and/or like commands. Upon completion of these commands, the content loader 430 may send responses to a board management tool (e.g., via a ActiveMQ interface).

### DFS Cluster

In some embodiments, post content may be stored DFS 440. For example, in one embodiment, the DFS may be a Hadoop Distributed File System (HDFS). HDFS is a distributed file system designed to run on commodity hardware which is highly fault-tolerant and is designed to be deployed on low-cost hardware. HDFS provides high throughput access to application data and is suitable for applications that have large data sets. HDFS has a master/slave architecture, and an HDFS cluster consists of a single Namenode, a master server that manages the file system namespace and regulates access to files by clients. In addition, there may be a number of Datanodes, usually one per node in the cluster, which manage storage attached to the nodes that they run on. HDFS exposes a file system namespace and allows user data to be stored in files. Internally, a file may be split into one or more blocks and these blocks are stored in a set of Datanodes. The Namenode may execute file system namespace operations like opening, closing, and renaming files and directories. It may also determine the mapping of blocks to Datanodes. The Datanodes may be responsible for serving read and write requests from file system's clients. The Datanodes may also perform block creation, deletion, and replication upon instruction from the Namenode. In other embodiments, other file systems may be utilized.

### ESP Cluster

Some embodiments may utilize one or more ESP clusters 450. For example, one embodiment may utilize a FAST ESP engine to index post content. A FAST Content API may be used by the content loader 430 to upload documents into FAST and the FAST Search API may be used by the front-end to obtain results. The FAST cluster may also communicate with a stats database (e.g., Oracle or the like) in order to retrieve the updated values of the thread stats (e.g., total replies and total views).

### Error Cases

In some embodiments, error types may be determined. By way of non-limiting example, the following types of errors may be generated by the system: scheduler DB connection errors, worker DB connection errors for a particular board, worker parse errors, HTTP connection errors, queue errors, and/or the like.

### Debugging Tools

Depending on the implementation, a number of tools may be provided and/or utilized for debugging. For example, one embodiment may have a tool that takes in a board URL, forum ID and thread ID as input parameters and returns whether the board was successfully processed.

### Filters

In some embodiments, the FFS may provide one or more filters to searching users. The filter or filters may be applied based on user-specifications (e.g., a registered user specifies filter and/or content preferences), default setting (e.g., searches by non-registered users may be filtered to exclude adult material), user location (i.e., certain filters may be required by local and/or national laws), and/or the like.

### Safe Filter

In one embodiment of the FFS, one or more safe filters may be provided to users. As discussed above, there may be multiple means by which content is flagged to be included as part of what constitutes offensive content. When a user chooses a safe filter to be enabled/on, content which is tagged as Adult (e.g., at the forum level), and/or any individual posts tagged as offensive (e.g., based on an offensive word list), may be excluded by the filter. In one embodiment, new content may specified for flagging/tagging. For example, a new word could be added to an offensive word list. In one embodiment, the FFS may re-index previously indexed content to identify forums and/or entries that contain the word, while in other embodiments, the flagging/tagging of the presence of the new word may only be applied to new forums or entries, and/or upon period re-indexing. In a further embodiment, search results may be analyzed for the new word before being provided to the searching user. In one embodiment, if a query contains a teen or terms that are in an offensive word list, the user may receive a warning/opportunity at the top of the results allowing them to turn on a safe filter.

In some embodiments, the FFS may provide an adult filter. In one implementation, the adult filter may apply to entire sites and/or forums and associated content designated by the FFS as adult-oriented. In one embodiment, the FFS may provide an offensive content filter (distinct from an adult filter) that filters forums and/or posts based on, for example, the presence of words that are on a FFS offensive word list. In a further embodiment, the FFS may provide users or the like with the ability to create and/or customize filters to their own preferences. In one embodiment, the FFS may provide a legal filter that filters sensitive or forbidden content. For example, a certain country may have laws that restrict certain content, and for users searching from that country (e.g., as identified by IP address), the FFS may apply the indicated legal filter to content.

In one embodiment, when a user selects a link to a forum that may not have yet been completely indexed and/or analyzed by the FFS, the user may receive a notification (e.g., a pop-up) that the forum has not be reviewed for content and may contain undesirable content.

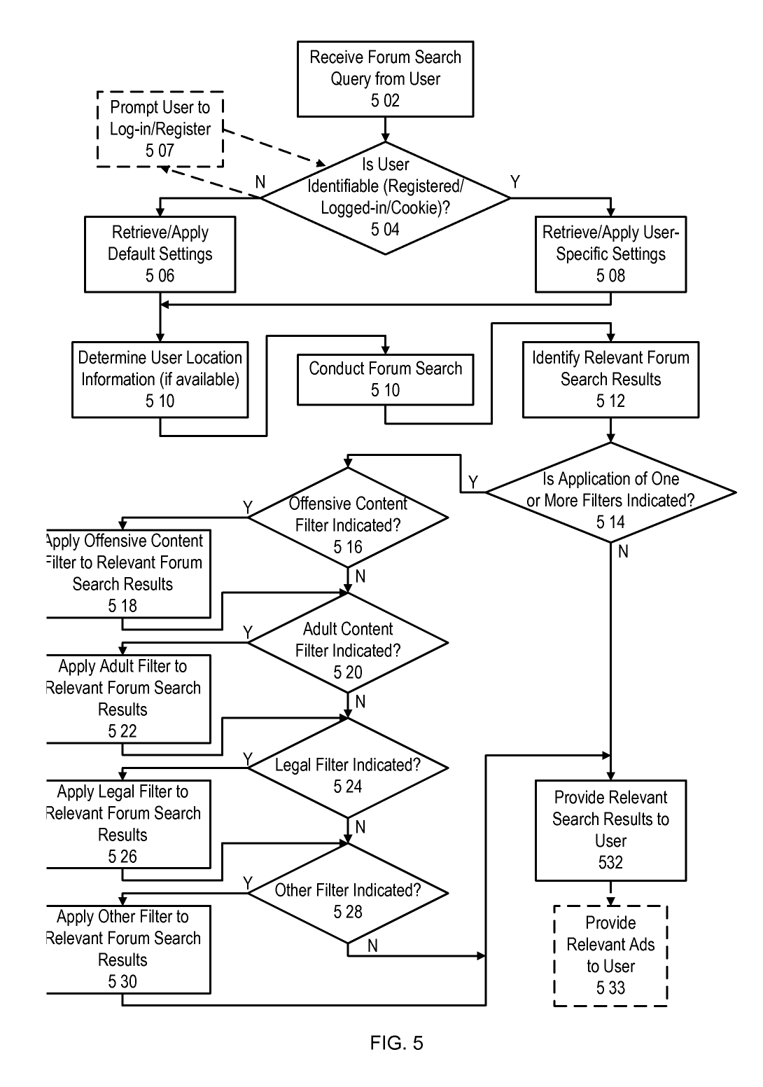

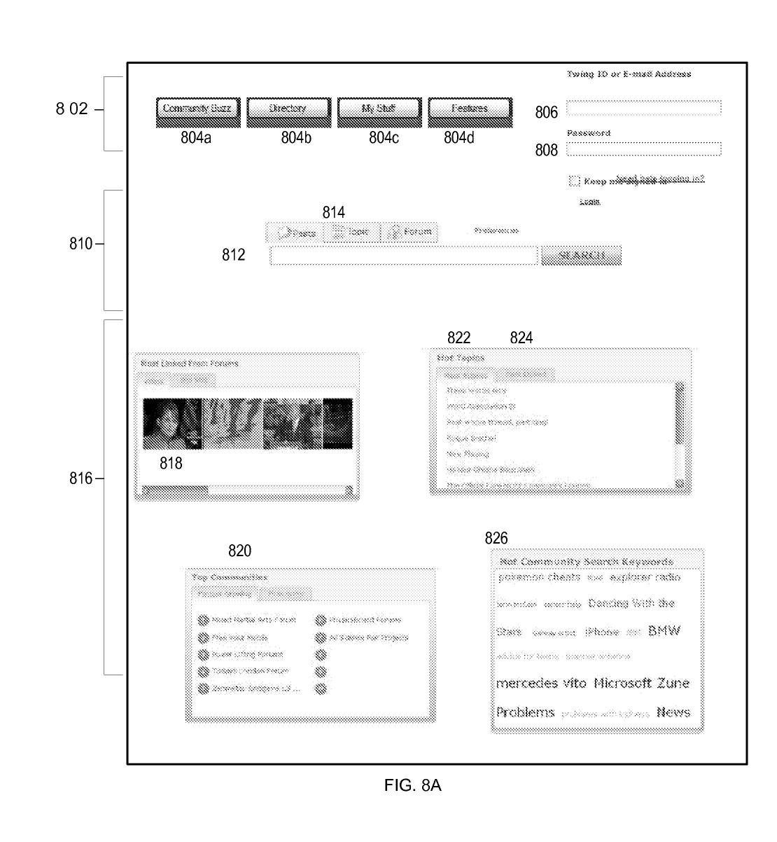

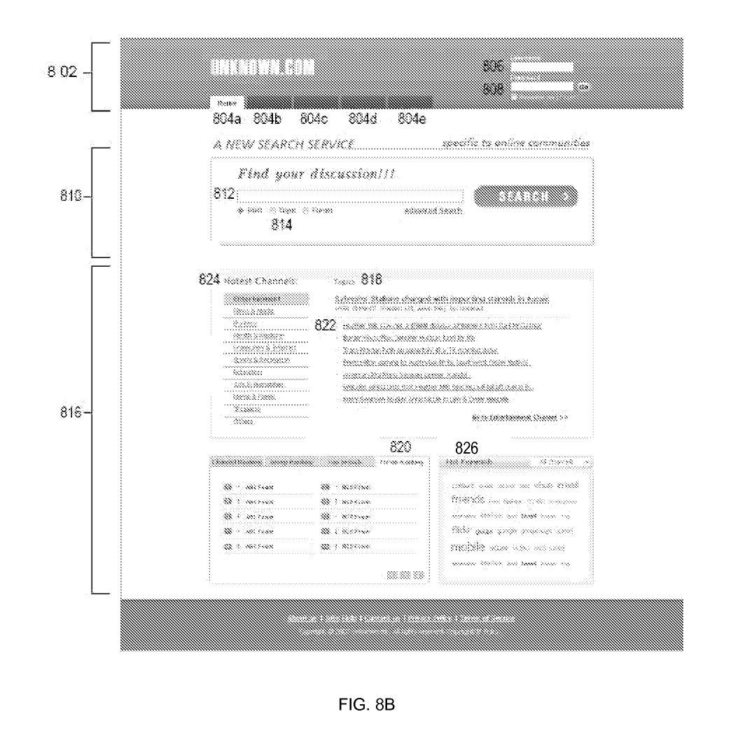

FIG. 5 provides a flow diagram illustrating aspects of filtering for one embodiment of the FFS. The FFS may receive a forum search query from a user 502 (e.g., via a FFS user search interface, as described in FIG. 8). The FFS may then determine if the user is know or identifiable 504 (e.g., if the users is registered/logged-in to the FFS and/or is a returning user with a cookie and/or the like). If the user is identifiable 504, the FFS may retrieve and apply user-specific settings 508 (e.g., from a user database). If the user is not identifiable 504, the FFS may apply default settings 506. In some embodiments, if a user cannot be identified 504, the FFS may prompt the user to register and/or login 507 before proceeding, while in another embodiment, the FFS may require the user to register and/or login before proceeding.

In some embodiments, the FFS may then determine user location information 510 (e.g., from user settings, cookies, IP address, etc.). The FFS may then conduct a search of forum information based on the received query 510. In some embodiments, additional information, such as the user's location and/or other user information (i.e., search history, user profile, language preferences, and/or the like, which may, for example, be stored in a user database) may augment and/or influence the search of forum information. The FFS may then identify the relevant results of the forum search 512.

The FFS may then determine if the application of one or more filters is indicated 514 (e.g., indicated by the user-specific settings, default settings, location information and/or the like). If the FFS determines that filtering is indicated 514, the FFS determines if an offensive content filter is indicated 516 and if so, applies the filter to the identified relevant forum search results 518. In one embodiment, if a search result is caught by the filter, the result may be removed from the results provided to the user. In another embodiment, the result may have a flag or other indication associated with it to inform the user that the filter has identified it. In a further embodiment, access to the flagged result may be restricted (e.g., the user may be required to register and/or log-in to see and/or access the result). The FFS may then determine if an adult content filter is indicated 520 and if so, applies the filter to the identified relevant forum search results 522. Similarly, the FFS may determine if a legal filter 524 and/or other filter 528 is indicated, and if so, applies the one or more indicated filter(s) to the identified relevant forum search results 526, 530. The FFS may then provide the forum search results to the user 532. In some embodiments, the FFS may also provide advertisements to the user 533. In one implementation, the FFS may select advertisement based on the returned forum search results and/or user information (e.g., location, profile, search query, etc.).

As discussed above, the FFS may apply legal and/or adult filters to certain users based on their location (e.g., as determined by IP address). The application of the filter may be indicated based on content restrictions associated with the laws of the country or state of a searching user. In one embodiment, the FFS may utilize a provider (e.g., Quova and/or the like) to determine inbound traffic from indicated IP addresses. Results offered to users from the indicated IP addresses are checked for flags/tags of disallowed content types (e.g., illegal/adult content). As discussed above, in one implementation, flags may be set for adult forums or boards on the board/forum level, either automatically via the FFS and/or manually via user and/or administrator input. Post-level flags and/or tags may be assigned based on post content (e.g., during indexing of the forum, based on matching a word list). In some implementations, the FFS may utilize a run-time filter configured to match new word (and/or other content) exclusions added to either adult or legal lists since the last indexing/ferreting. New words and/or content may also be added to a master list or lists such that re-generated indexing will identify and note them, at which point they may be removed from the run-time check. In a further embodiment, multiple implementations of the FFS may be utilized to address differences in filtering requirements across regions, nations, and/or states. For example, if neighboring countries had different filtering requirements, each country may utilize a unique implementation of the FFS.

In addition to determining the relevance forum search results (e.g., posts) based on an entered query, the FFS may determine a post relevance rating and/or result list order based on a number of other indicators, including but not limited to: post length, direct and/or indirect responses to post, relationship to other relevant posts, quotations from post, other user feedback to post, post author, post author ranking/rating, and/or the like. In one embodiment, the FFS may first identify relevant forum posts based on a received query. For example, a user may enter a number of terms, and the FFS may identify forum posts that contain some or all of the entered terms. Of the identified posts, the FFS may examine post length to help determine relevance or importance. For example, a post that is only two lines long may be determined to be less relevant than a post that is ten lines long, while the same two line post may be determined to be more relevant than a post that is over one hundred lines long. Relevance may further be determined based on an analysis of the relationship of relevant terms in the post. For example, while two posts of the same length may both contain the same number of instances of the searched terms, a post that has some of the search terms within close proximity (e.g., in the same sentence) may be determined to be more relevant than a post that contains the indicated search terms but spread out (e.g., not in the same sentence). In a further embodiment, the FFS may adjust the parameters of the assessment based on the subject matter of the board, forum, and/or thread. For example, the optimal post length range for relevance on a technology-related forum may differ from the optimal post length range for a political forum. In a further embodiment, the FFS may be equipped to respond to user behavior and/or feedback to enhance post relevance assessment.

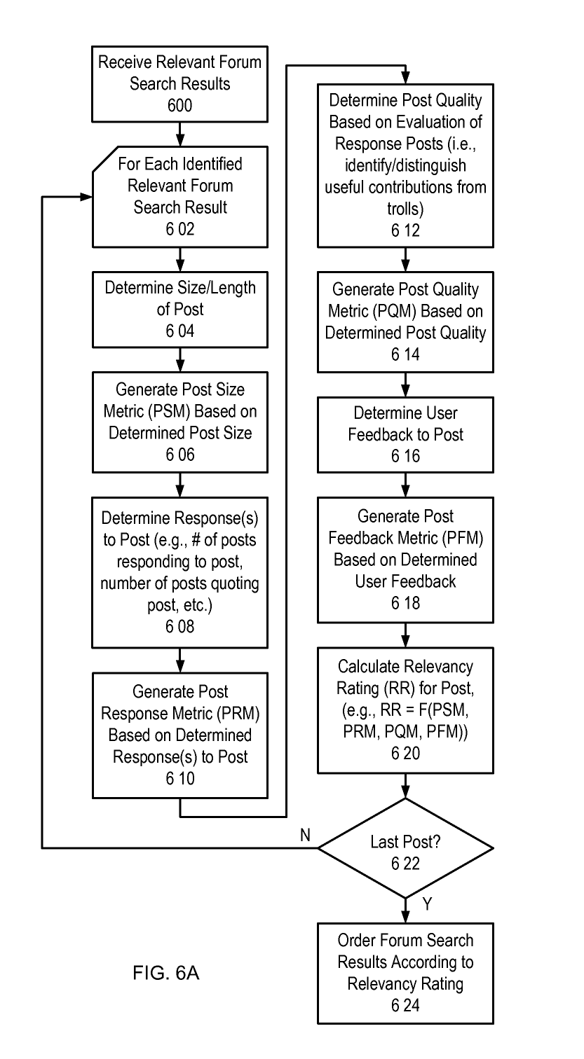

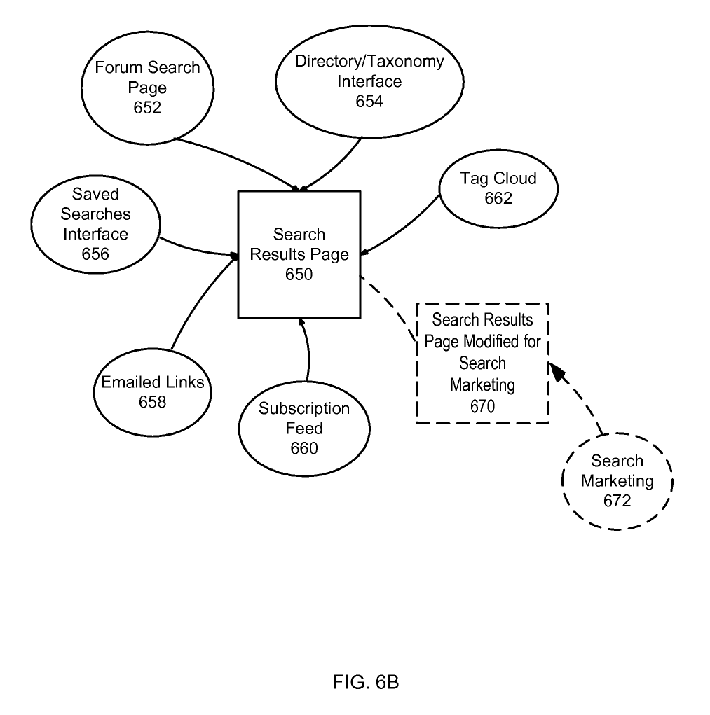

FIG. 6A provides a logic flow diagram illustrating the determination of a relevancy rating and ordering for forum post search results in one embodiment of the FFS. As shown in the figure, relevant forum search results are received 600, for example, after the relevant forum search results have been identified or before search results are supplied to a user (512 or 532 in FIG. 5, respectively). For each identified relevant forum search result 602 (e.g., post), the FFS determines the size and/or length of the post 604 (e.g., performs a word count) and may generate a post size metric (PSM) based on the determined post size 606. For example, in one embodiment, the PSM may correspond directly to the post length, such that the longer the post, the larger the corresponding PSM. In another embodiment, the PSM may be determined according to criteria such that very short posts and very long posts are given PSMs that indicate a lower desirability or relevance (e.g., a small PSM), while posts with lengths that are determined to be optimum (e.g., 5-15 lines of text) are given PSMs indicating a higher desirability or relevance (e.g., a large PSM). As discussed above, optimal post length may be category and/or search specific.

The FFS may then determine the number of subsequent responses to the post 608. Depending on the implementation, the number of responses may be based on post that respond to the post (in a threaded forum environment), as well as posts that respond to those posts, and so on. In an alternative or additional embodiment, the FFS may determine the number of responses based on subsequent posts that quote the post in question and/or that address the author of the post in question. Other embodiments may determine the number of responses (direct and/or indirect) to a post, and may further determine a particular weighting to such responses (e.g., one or two word responses are not weighed as heavily as longer responses). The FFS may then generate a post response metric (PSM) based on the determined responses to the post 610. The FFS may then determine post quality based on an evaluation of the response posts 612. In some embodiments, based on the evaluation, the FFS may distinguish between relevant posts that create a discussion and irrelevant posts (e.g., trolls, flames and/or threadjacks) that may generate a number of responses but are not particularly relevant. The FFS may then generate a post quality metric (PQM) based on the determined post quality 614. In some embodiments, the FFS may then determine other users' feedback to the post 616. For example, some forums may allow users to rate or rank posts, and/or give binary feedback (e.g., thumbs up/down) for particular posts and/or users. Based on the determined user feedback, the FFS may then generate a post feedback metric (PFM) 618.

Based on one or more of the determined metrics, the FFS may then calculate a relevancy rating (RR) for the post 620, where the RR is a function of one or more of the determined metrics. For example, in one embodiment, the RR may be the summation of indicated metrics, such that a higher RR indicates higher relevancy. If the post is not the last post of the relevant search results 622, the FFS determines RR for the remaining posts, and once all posts have a RR, the forum search results may be ordering according to their respective RR 624. While the above embodiment was directed towards posts, other embodiments may alternatively or additionally be directed towards threads, topics, forums, and/or the like.

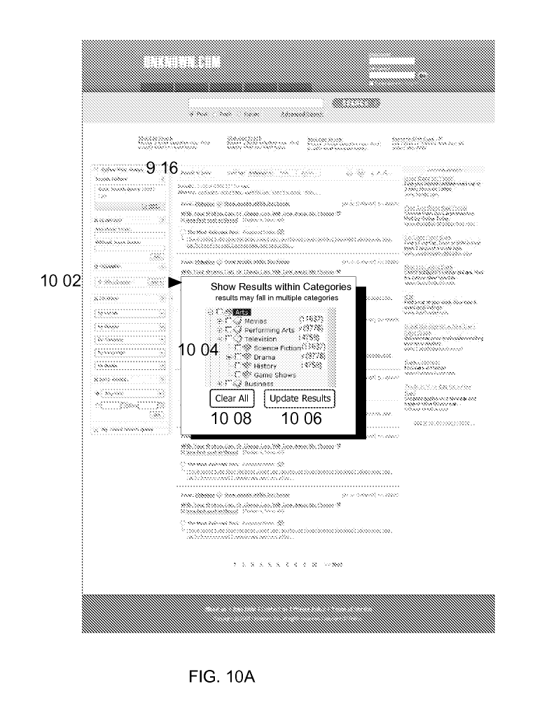

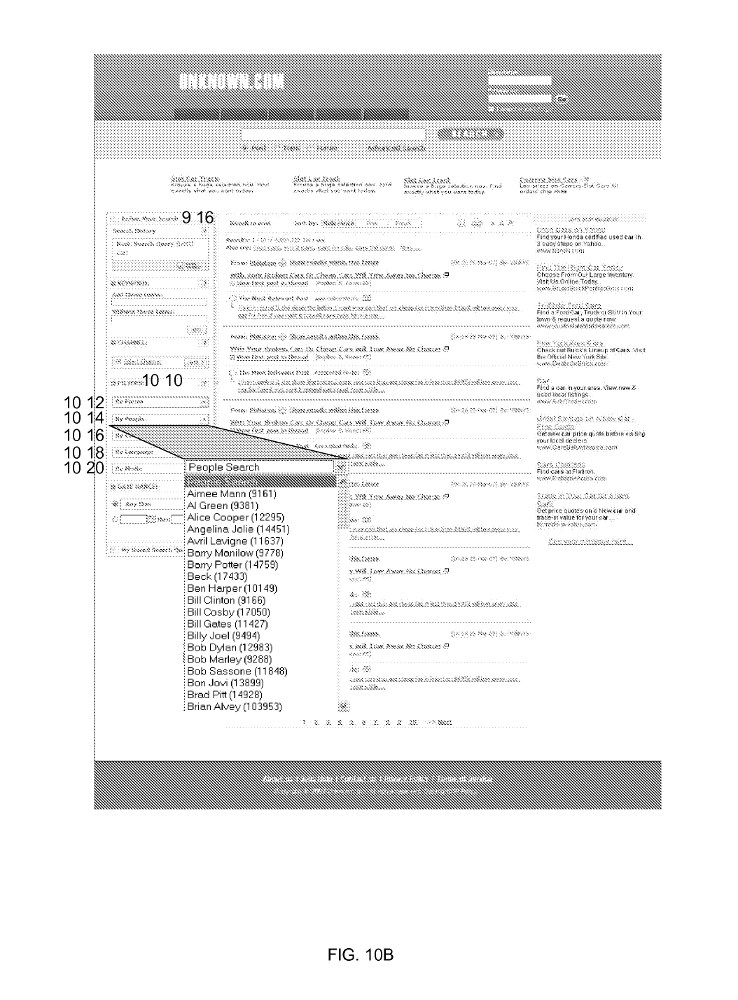

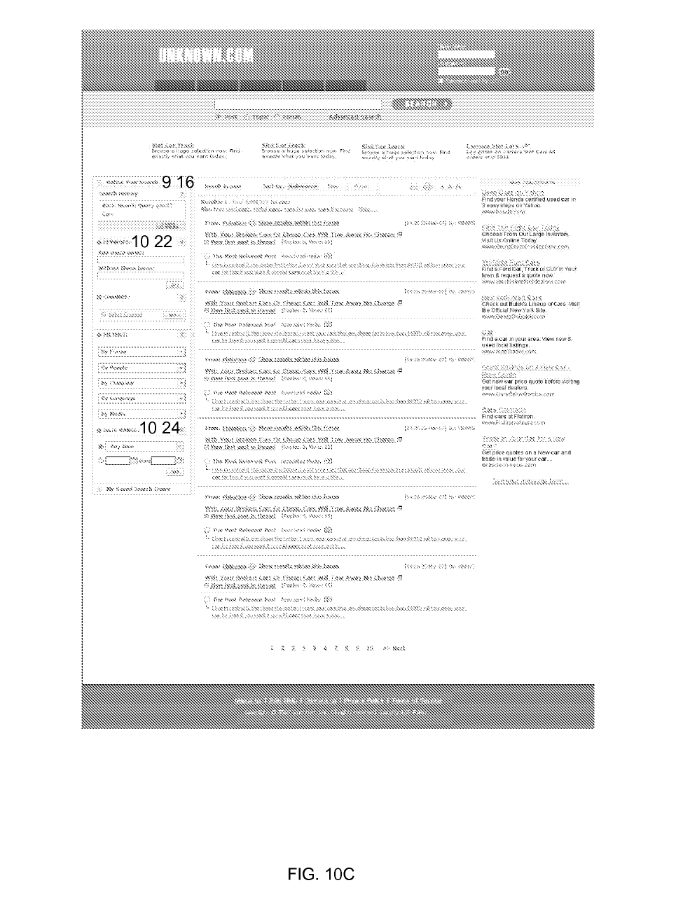

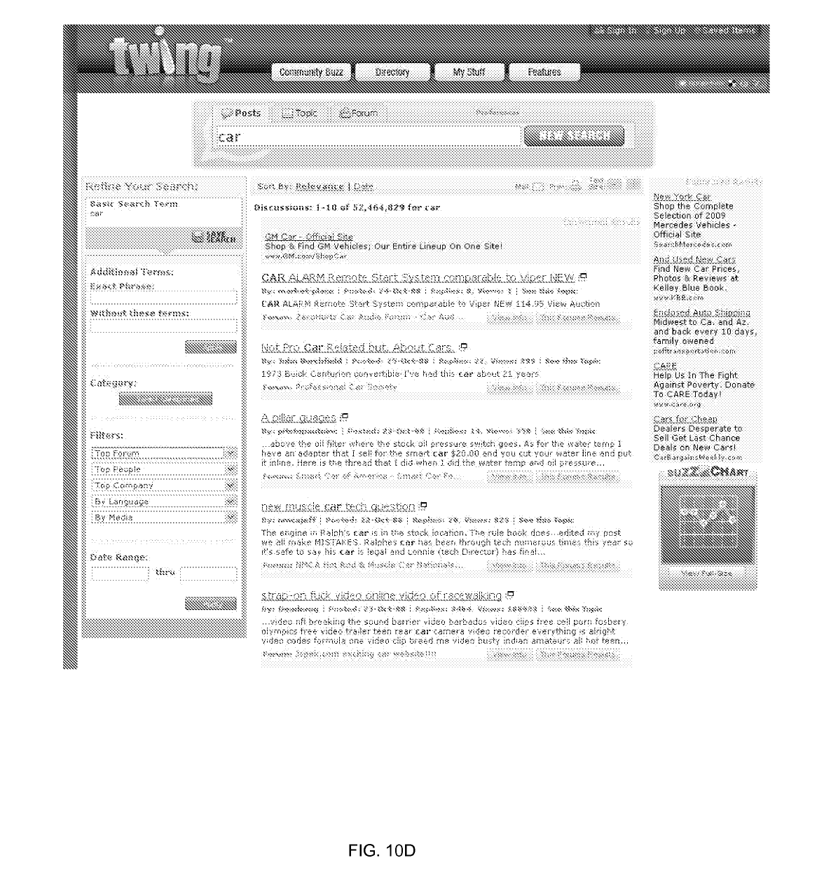

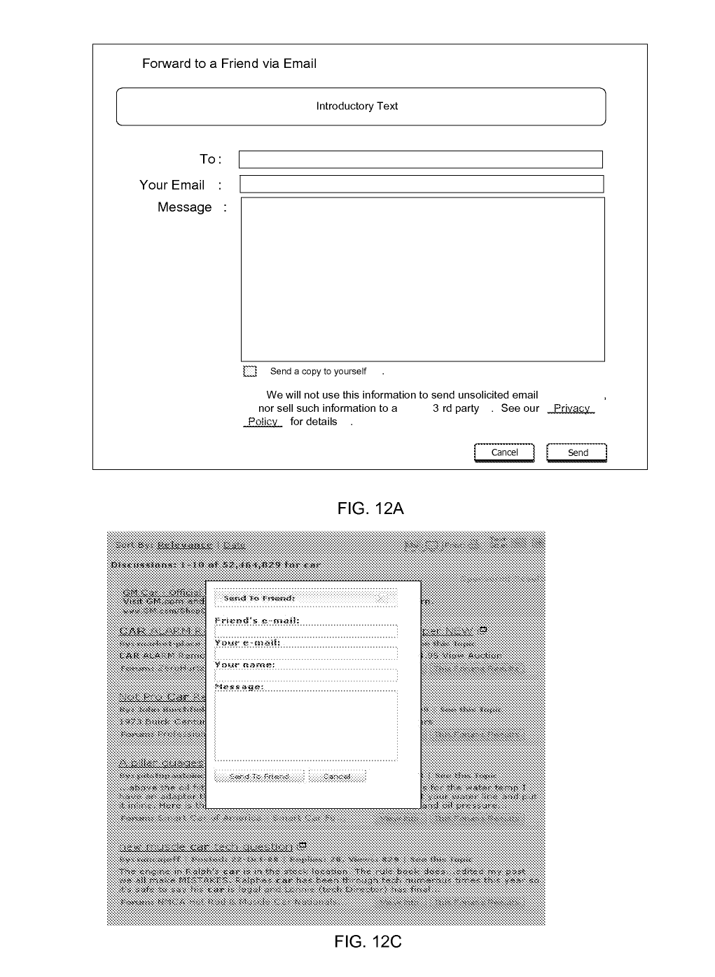

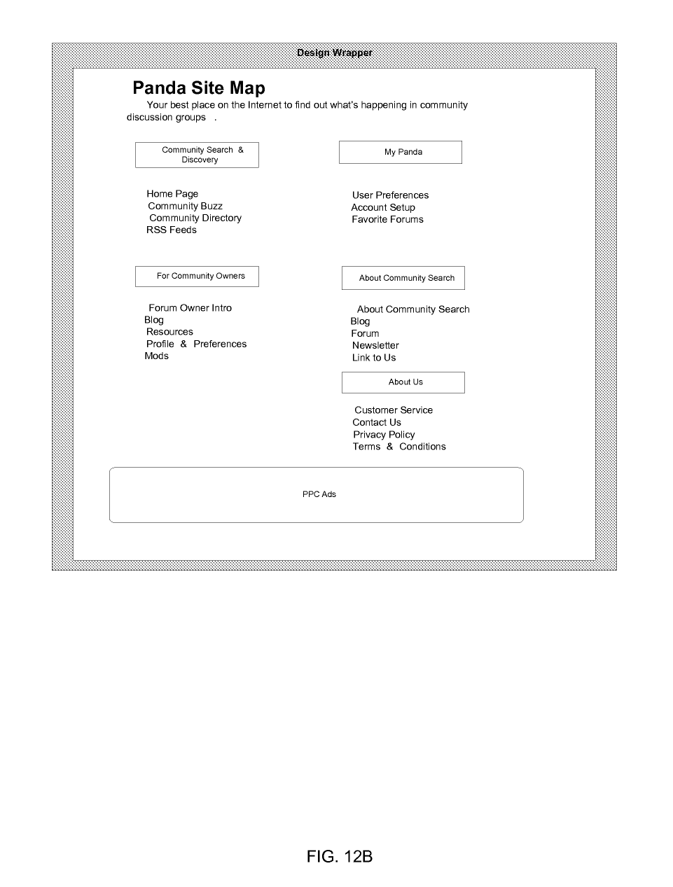

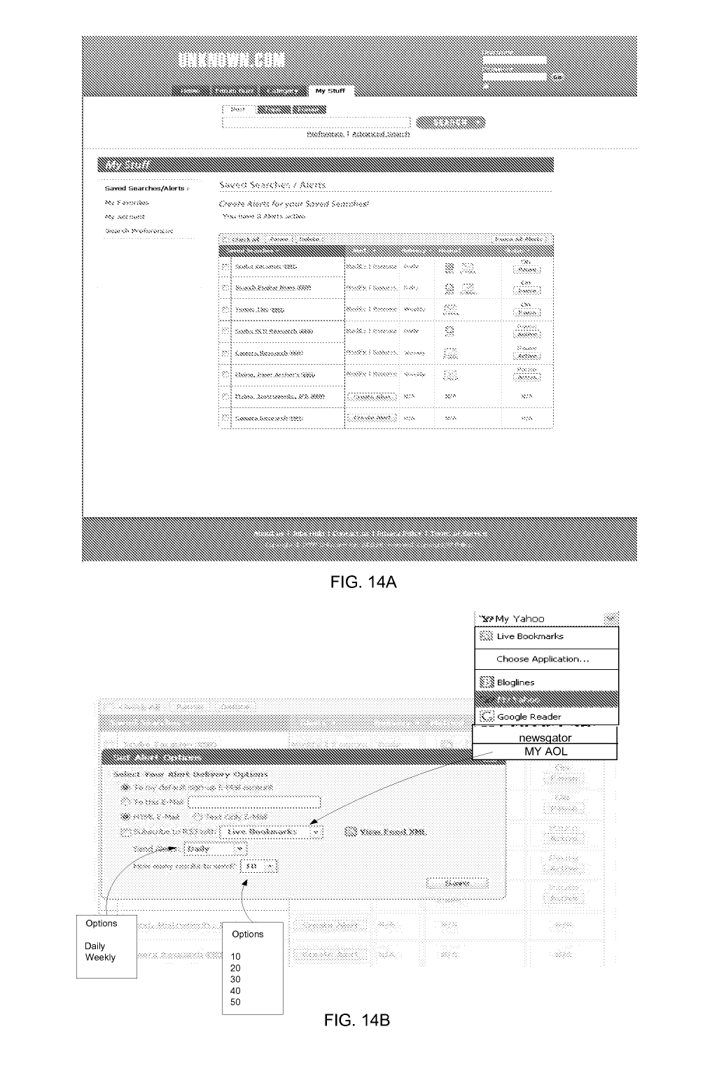

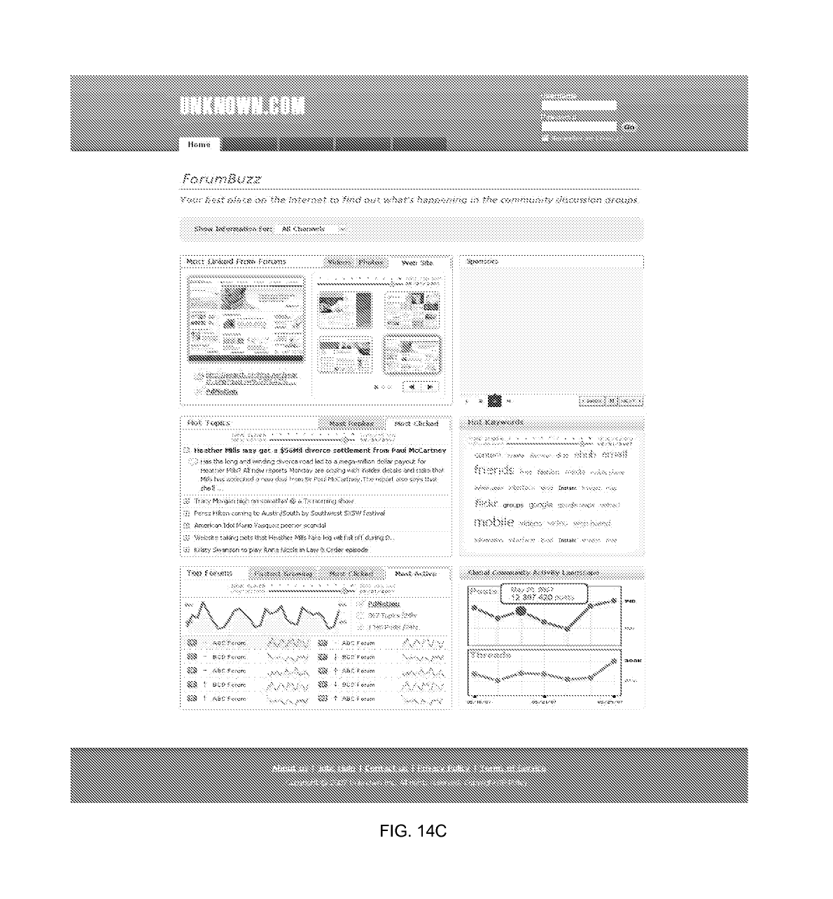

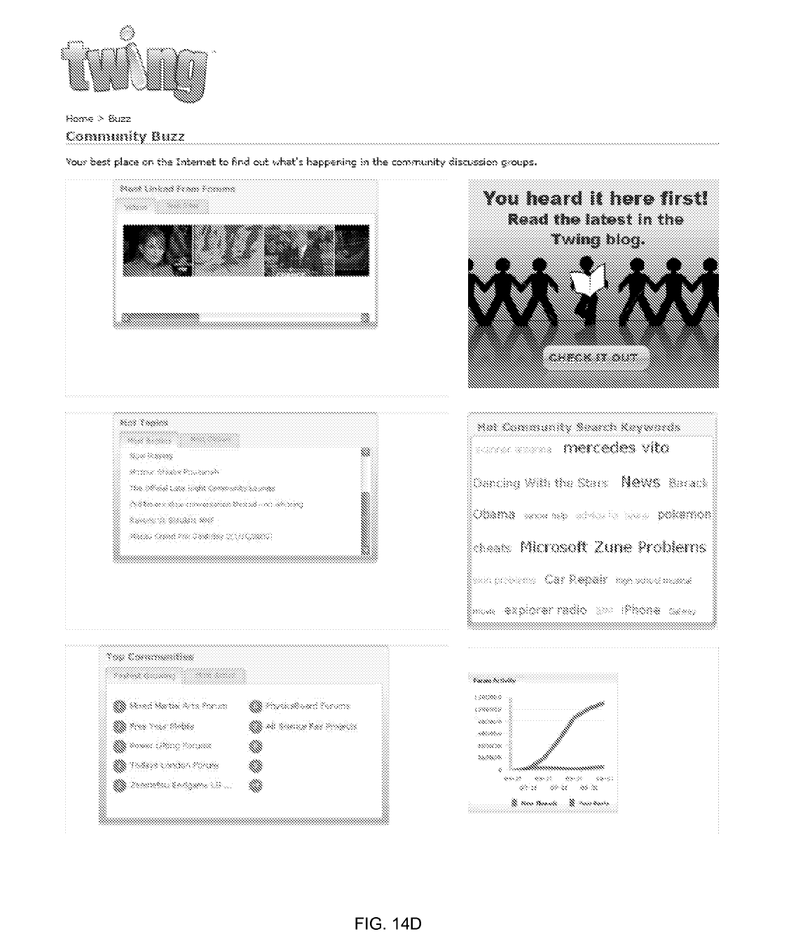

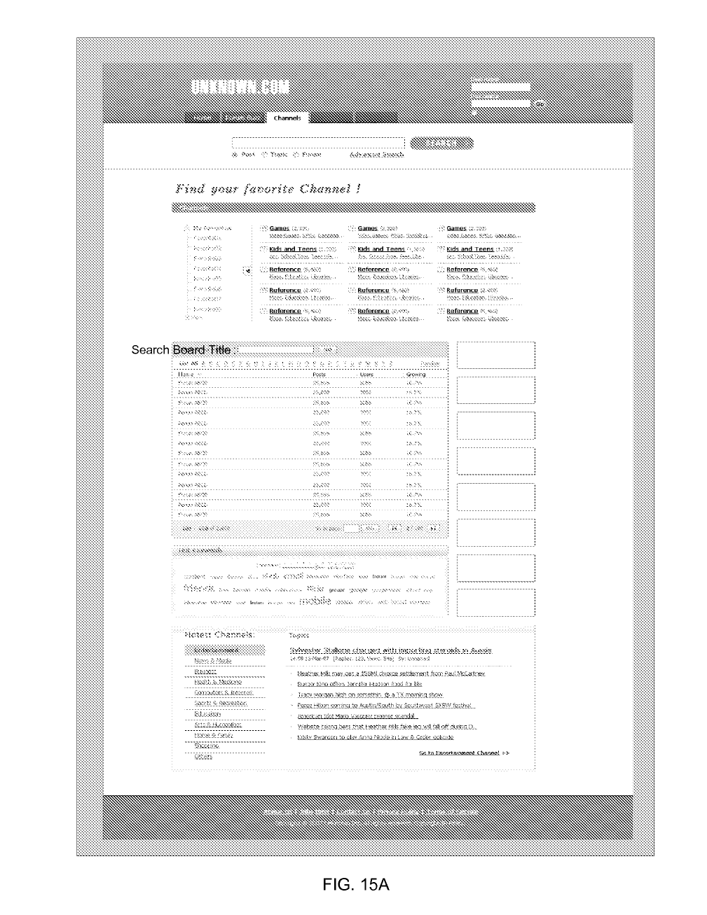

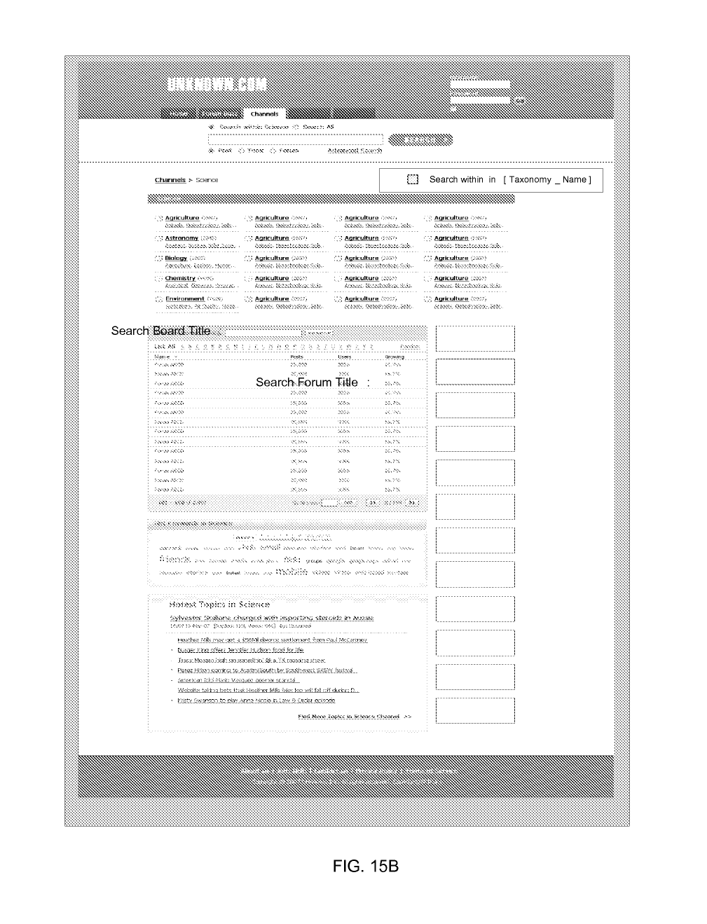

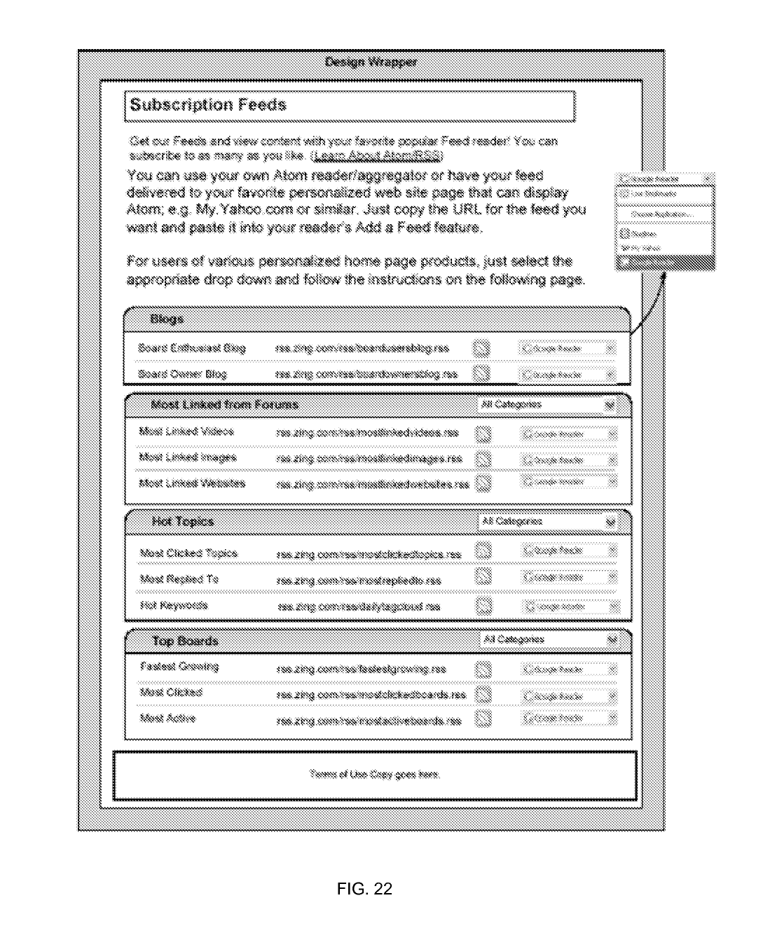

FIG. 6B provides an overview diagram for an embodiment of the FFS illustrating user access points for forum search results. As shown in the figure, users may be directed to a search results page 650 from a forum search page 652 (e.g., as described in FIG. 8), a directory/taxonomy search interface 654 (e.g., as described in FIG. 10A), a saved searches interface 656 (e.g., as described in FIG. 14A), an emailed link 658 (e.g., as described in FIG. 12A), a subscription feed 660 (e.g., as described in FIG. 22), a tag cloud 662 (e.g., 828 in FIG. 8), and/or the like. In some embodiments, the search results page may be modified for marketing 670, including modifications for search marketing 672. In one embodiment, such a page may provide search results based on one (or more) inbound link(s) along with contextually appropriate introductory text. In some such embodiments, the page 670 provides contextually appropriate landing target for inbound direct marketing efforts, including, but not limited to, pay-per-click marketing efforts and/or the like.

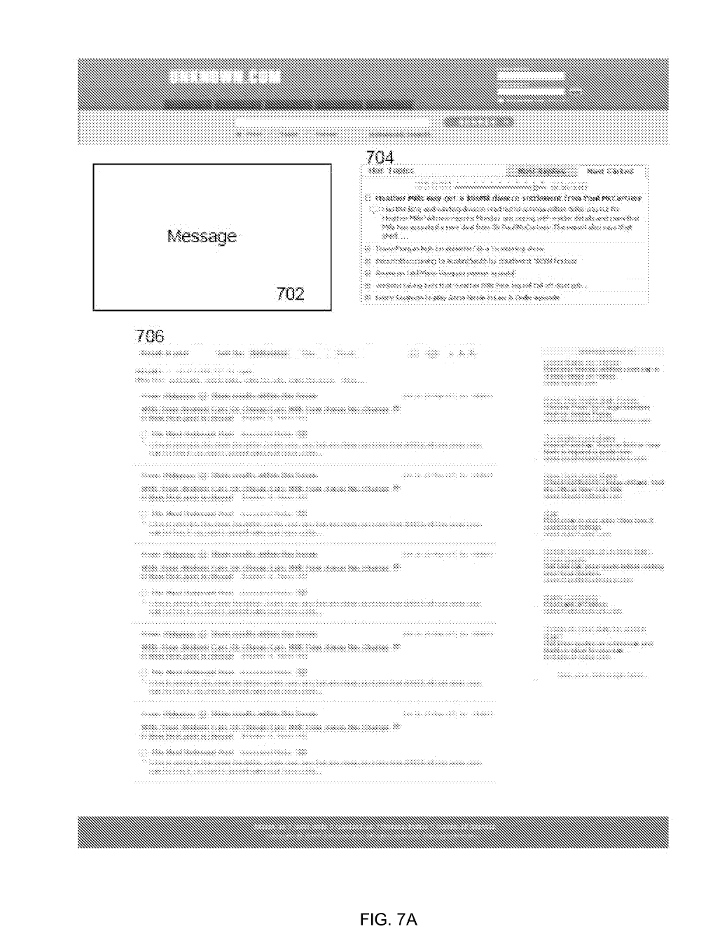

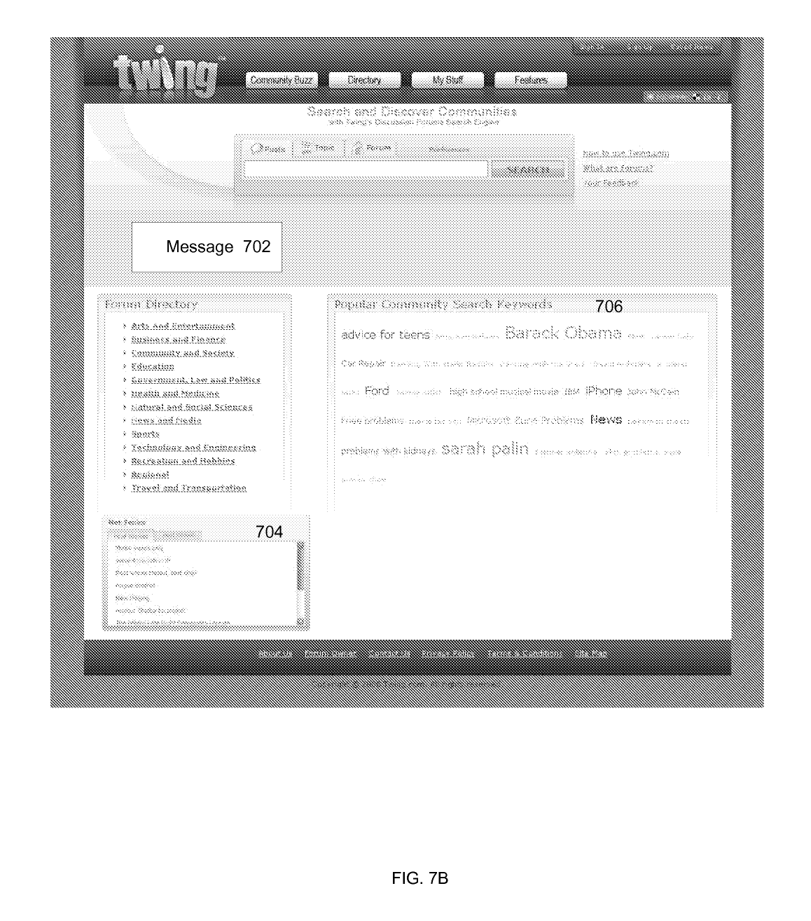

FIGS. 7A and 7B illustrates an example landing page user interfaces for embodiments of the FFS. The interfaces shown provides an example FFS marketing landing page that provides a contextually appropriate landing target for inbound direct marketing efforts, for example, pay-per-click (PPC) marketing efforts. These landing pages may be a new user's first experience-with/exposure-to the FFS, and may show forum search results of value to the user and may also provide an editorial messaging to convey a sense of the overall value of the FFS. In one embodiment, this is accomplished via a small block 702 expressing the FFS's value proposition, a “Hot Topics” widget 704, and/or a popular keywords/search widget 706 that conveys the breadth provided by the FFS, while depth and comprehensiveness is provided via the forum search results themselves.

In some embodiments, the forum search results consist of the first group of results (e.g., 10 results) based on the keywords embedded in an inbound link query string. These links may be pre-set based on extensive keyword research and creation of various PPC campaigns. In one implementation of the FFS, there may be thousands of key terms across many separate campaigns running at any given time. In one embodiment, the inbound links may also contain name/value pairs indicating the source of the link in order for product analytics to track back the performance of various campaigns and individual key word buys.

FIG. 8A illustrates an example homepage interface for one embodiment of the FFS. The homepage interface shown provides a masthead 802 that may provide intra-site navigation tools 804a-804d and/or allow a user to login to the FFS by entering their username 806 and password 808, or like login procedure. The homepage interface also provides a main search interface 810 where a user may enter a forum search query 812 and specify the scope of the search 814 (e.g., whether the search scope will be post, topic or forum).

The homepage interface may also provide editorial components or like information of potential interest to users or other site visitors beyond the search functions 816. Depending on the embodiments, such information may be generated by the FFS, generated semi-automatically (e.g., where a human editor checks FFS output before forwarding to the site), and/or human driven. As users may have differing interest, in some embodiments the determination of what information to provide may be based on an analysis of the user (e.g., login profile, cookies, history, etc.). Individual features may be designed as stand-alone modules which may be called into the home page as desired or used in other editorial features. In one embodiment, editorial features may include a feature story 818, visualizations at a global and/or board level (e.g., show most active boards 820 (e.g., in terms of post volumes over time), show hottest topics 822 and/or channels 824 (e.g., in terms of post volumes over time), show/graph overall sentiment over time (globally and/or at the board/forum level) for a particular topic, show most popular searches and/or keywords 826 (either filtered or not, depending on the implementation)), and/or the like. In some embodiments the editorial features may be interrelated. For example, if a user selects a particular channel 824, the interface may show the most active boards 820 for that channel and/or the most popular keywords 826 for that channel. FIG. 8B illustrates an example homepage interface for another embodiment of the FFS.

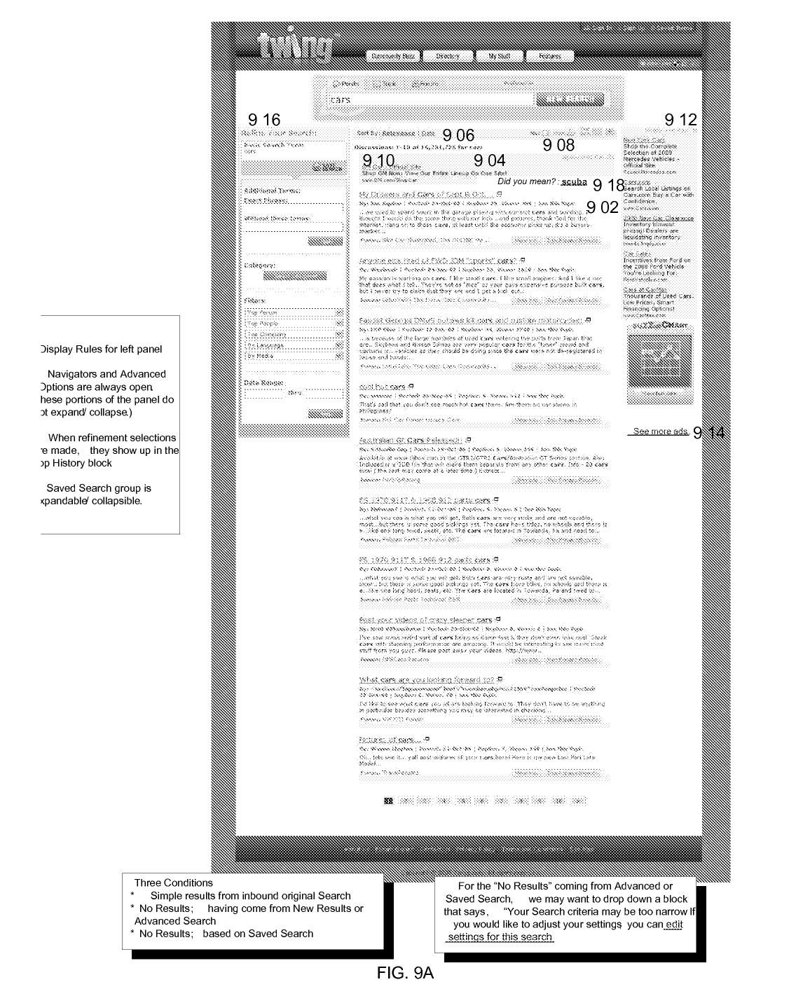

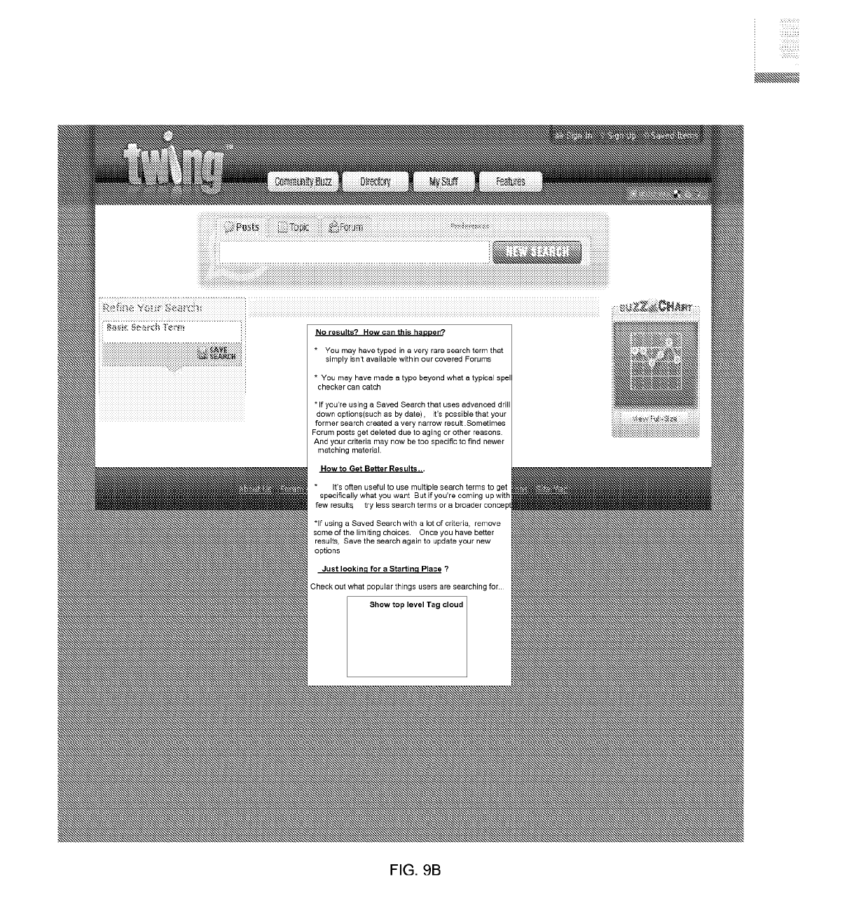

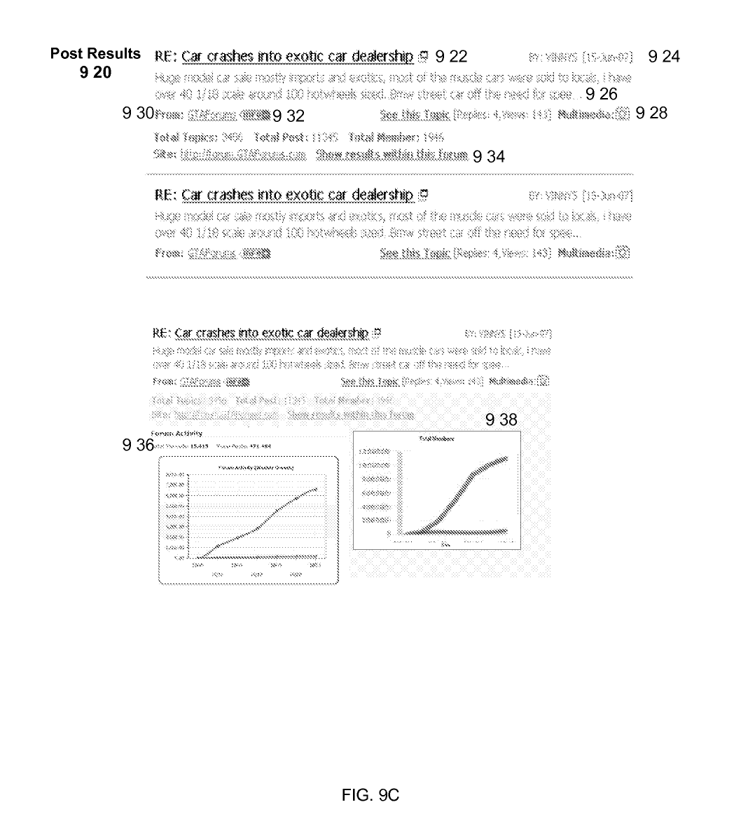

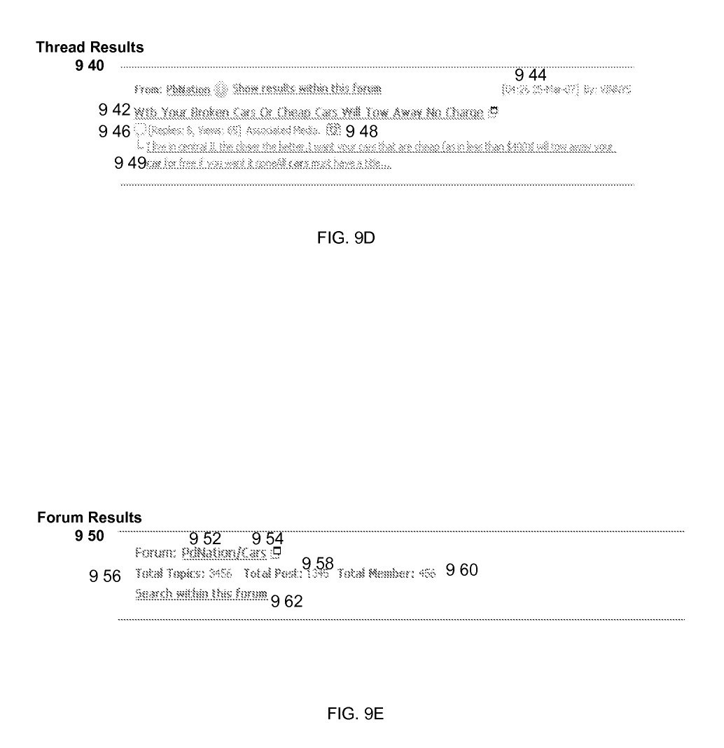

FIG. 9A illustrates an example forum search results page interface for one embodiment of the FFS. The forum search results page interface shown provides the forum search results 902 (in this figure, the forum post search results). In some embodiments, the interface may provide a forum search results status bar or the like. The status bar may provide data on the results (e.g., results x of y of nnn total posts for search term(s) 904), sort options 906 (e.g., relevance, time, forum, clarity, etc.), and/or print icon, font size change, and/or like icons 908. The interface may also provide a number of tools to allow a user to refine/target the search 916.

In one implementation, the search results page interface may provide a “Did you mean:” (DYM) tool 918 to assist in correcting possible errors (e.g., spelling errors). In one embodiment, the DYM tool may disappear upon a user action selecting a function that updates the search results page (e.g. a navigator selection). The DYM tool may reappear if it is triggered by entry of additional terms (e.g., user entering words in the left side refinement area).

The interface may also display advertisements 910, 912. Depending on the embodiment, the advertisements may be selected based on the search terns entered by the user, the search results provided to the user, and/or according to other parameters. The interface may also provide tools for a user to see more ads 914 (e.g., more ads relating to their forum search).

FIG. 9B provides an example forum search results page interface for an embodiment of the FFS illustrating what a user may see if no forum search results are identified by the FFS.

FIG. 9C illustrates how some embodiments of the interface may provide additional information on forum post search results. In one embodiment, when providing forum post results to a user 920, the interface may provide link text 922, for example, the subject line from a post. If a post has no subject line, the link text may be the thread title text. If the publish time/date of the post is available, the interface may provide a time/date stamp 924 indicating such information. The interface may also provide a snippet from the post 926 (e.g., selected section(s) from the post, with ellipsis, bolded/highlighted key terms, etc.). In one embodiment, the interface may also indicate if there is media associated with the post 928 (e.g., an indicator that the post contains embedded audio, pictures, video, etc.). Additional information may also be provided by the interface including the forum/board the post is from 930. In one embodiment, an information icon 932 may be provided by the interface where selection of the icon will provide additional board information such as total posts, replies, users, etc. The interface may also be configured to display (e.g., via a drop down box): a top of board link, total topics, posts, members (where available), and/or the like. The interface may also provide the user with a “Results from This Board” tool 934 to results to those from the indicated board. Such a tool may function as a filter/navigator and cause results to refresh with matching posts from only the indicated board. In one embodiment, the interface may provide a graph or like representation of the total posts 936 and/or total members 938 over a given time period (e.g., total posts over the last month with weekly data points).

FIG. 9D illustrates how some embodiments of the interface may provide information on forum thread search results. In one embodiment, when providing forum thread results to a user 940, the interface may provide a title for the thread 942, show time/date published 944, and if the information is available, may show the last time the thread was updated (i.e., when the most recent post was added to thread). The interface may also show the number of replies and/or views for each thread 946, indicate if there is media associated with the thread 948, and/or provide a link to the first post in the thread 949.

FIG. 9E illustrates how some embodiments of the interface may provide information on forum search results. In one embodiment, when providing board/forum results to a user 950, the interface may provide a board name 952 and, if available, a description of the board 954 and/or total topics 956, posts 958, members 960 and/or like information. The interface may also provide a tool to allow a user to search within the indicated forum 962 (i.e., search for a posts and/or threads within the forum).

FIG. 10A provides detail for a forum search results taxonomy selection interface for one embodiment of the FFS. As discussed above, the interface may provide a number of tools to allow a user to refine/target the search 916, and in one embodiment, the tools may include a taxonomy selection interface 1002 allowing users to select one or multiple channels or categories by which to narrow the results. In one embodiment, the selection of channels or categories allows users to choose relevant subject areas and avoid non-relevant results (e.g., synonyms). For example, if a user enters the search term “bass” the FFS may return posts relating to bass fishing and bass guitars. A user could utilize a category tool to narrow the scope of the search to the relevant topic or topics. In the embodiment shown in the figure, the interface allows the user to scope their search to the taxonomy space(s) of interest via check boxes 972 which specify branches of taxonomy. With the provided tool, a user may select one or more categories 972 and update the results 974. The user may also clear indicated categories 976 to return to the original results. Depending on the embodiment, the taxonomy may be set according to FFS determination (i.e., determined by the FFS according to parameters), manual FFS administrator review, forum owner and/or relevant third party information, user-specified information, and/or the like.

FIG. 10B provides detail for forum search filter/navigator interface for an embodiment of the FFS. As discussed above, the interface may provide a number of tools to allow a user to refine/target the search 916, and in one embodiment, the tools may include filters and/or navigators 1010. Depending on the embodiment, the filter/navigators may include one or more of the following: a forum filter/navigator 1012, a people filter/navigator 1014, a company filter/navigator 1016, a language filter/navigator 1018, a media filter/navigator 1020, and/or the like.

In one embodiment, a forum filter/navigator 1012 allows scoping to a particular forum. For example, in one implementation, the filter/navigator may show the top fifty forums for a particular search. In a further embodiment, the number of relevant results in each of the forums may also be provided.

Some embodiments may provide people 1014 and/or company 1016 filter/navigators. In one implementation, such filter/navigators may utilize people and/or company lists or dictionaries to identify relevant individuals or entities associated with forum search results, and provide this information to users via the interface.

Similarly, some embodiments of the FFS may provide language filter/navigators 1018 that allow the scoping of results according to language. Depending on the embodiment, the FFS may determine the language according to a preset list of forum languages, an analysis of the forum to determine an associated language, an analysis of the returned posts to determine language, and/or the like. When a user selects a particular language, the forum search results are scoped to only include those results corresponding to the indicated language. In one embodiment, the interface may additionally, or alternatively, provide a media filter/navigator 1020 that allows a user to select forum search results (e.g., posts) that contain or reference specific media, including images, audio, video, and/or the like.

FIG. 10C provides detail for forum search keyword and date scoping interfaces for one embodiment of the FFS. As discussed above, in some embodiments, the interface provides a number of tools to allow a user to refine/target the search 916. The figure illustrates a keyword tool 1022 and date range tool 1024. The keyword tool 1022 allows a user to add more terms, enter terms to exclude, and/or specify exact phrases. The date range tool 1024 allows users to scope provided results to particular dates or a range of dates (e.g., dates when post was entered, thread created, last entry added to thread, etc.).

FIG. 10D provides detail for forum search filter/navigator interface for another embodiment of the FFS.

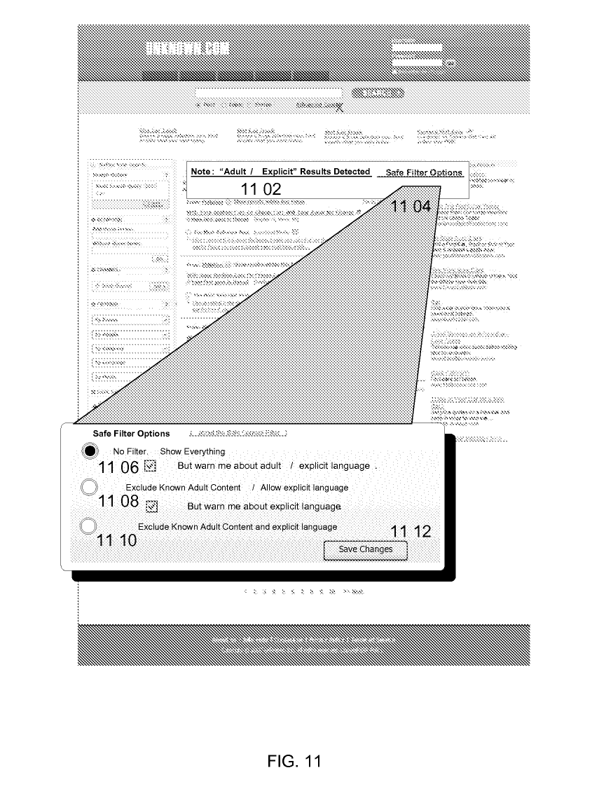

In some embodiments of the FFS, when returning results, the interface may provide warning and/or filtering of certain types of material. FIG. 11 provides an example interface illustrating an implementation of such an embodiment. In some embodiments, the interface may display an adult/explicit content warning 1102 if the content of returned forum search results matches safe filter settings.

In one embodiment, the rules for displaying a warning and/or applying a filter, as discussed above, may depend on criteria such as whether some results come from forums tagged as adult and/or whether results match one or more adult/explicit filter. The below table illustrates what actions one embodiment may be based on possible indications.

| | User Preferences & Settings | | | |
|---|---|---|---|---|
| | | | | Exclude Known |
| | No filter: Warn Me = | No Filter: Warn | Exclude Known | Adult Content & |
| Results | Yes | Me = No | Adult Content | Explicit Language |
| Clean Results | No warning | No Warning | No Warning | No Warning |
| | Show All results | Show All results | Show All results | Show All results |
| One or more | Show Warning | No Warning | No Warning | No Warning |
| result(s) are in | Show All results | Show All results | Exclude Adult | Exclude Adult |
| Adult Tagged | | | results. | Results |
| Forum | Show “adult | | | |
| | results only” link | | | |
| One or more | Show Warning | No Warning | No Warning | No Warning |
| results have | Show All results | Show All results | Show All results | Exclude Explicit |
| Explicit Language | | | | language results. |
| | Show “adult | | | |
| | results only” link | | | |
| One or more | Show Warning | No Warning | No Warning | No Warning |
| result(s) are in | Show All results | Show All results | Exclude Adult | Exclude Adult |
| Adult Tagged | | | results. | Results and |
| Forum AND one | Show “adult | | | Exclude Explicit |
| or more results | results only” link | | | language results. |
| have explicit | | | | |
| language. | | | | |

Different implementations may also have different defaults set for new/unknown users. Such an interface may allow a user to change safe filter options 1104. For example, a user may indicate that no filter is desired 1106, limit the filter to only adult content 1108, or exclude adult content and explicit language 1110. Users may also utilize the interface to request that warnings be given for adult content, explicit language, and/or the like. Depending on the implementation, the settings may be saved 1112 and/or associated with a user via cookies or the like, and/or via stored preferences in a user account (i.e., for a registered user). In one embodiment, the interface may allow a user to select for the display of adult/explicit content only.

FIG. 12A illustrates an example user interface for an embodiment of the FFS. The interface shown provides a mechanism whereby a user may forward FFS forum search information and/or content to one or more email addresses (e.g., a user may pass along relevant forum search results to other users and/or his or her own email account). In some embodiments, the user may also be allowed to include a message and/or short note. The format of the email may be determined by the FFS based on the particular content being sent. For example, in one implementation, when content is oriented towards search results, the appropriate format (e.g., XML or the like) may be used. FIG. 12C illustrates an example user interface for another embodiment of the FFS.

FIG. 12B provides an example site map interface for an embodiment of the FFS. The site map interface provides an overall map to features of the FFS. In some embodiments the site map may assist search engine robots to discover pages on one or more sites associated with the FFS. The site map interface may also provide users with an alternative way to navigate a site or sites associated with the FFS.

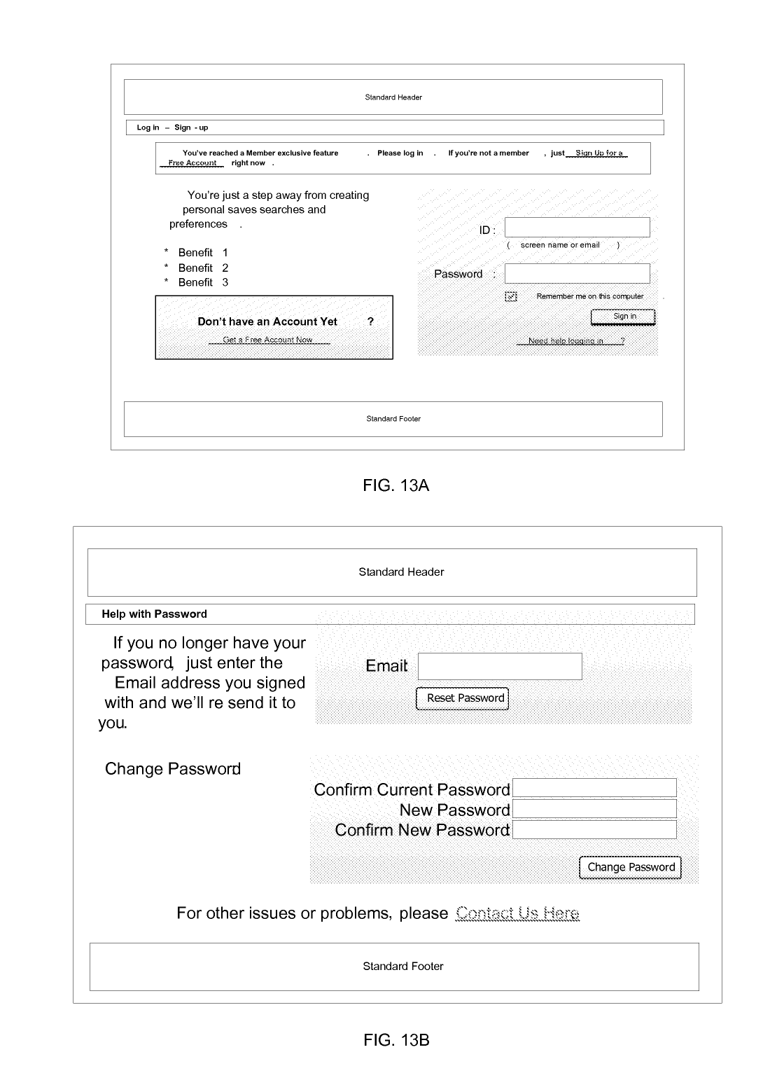

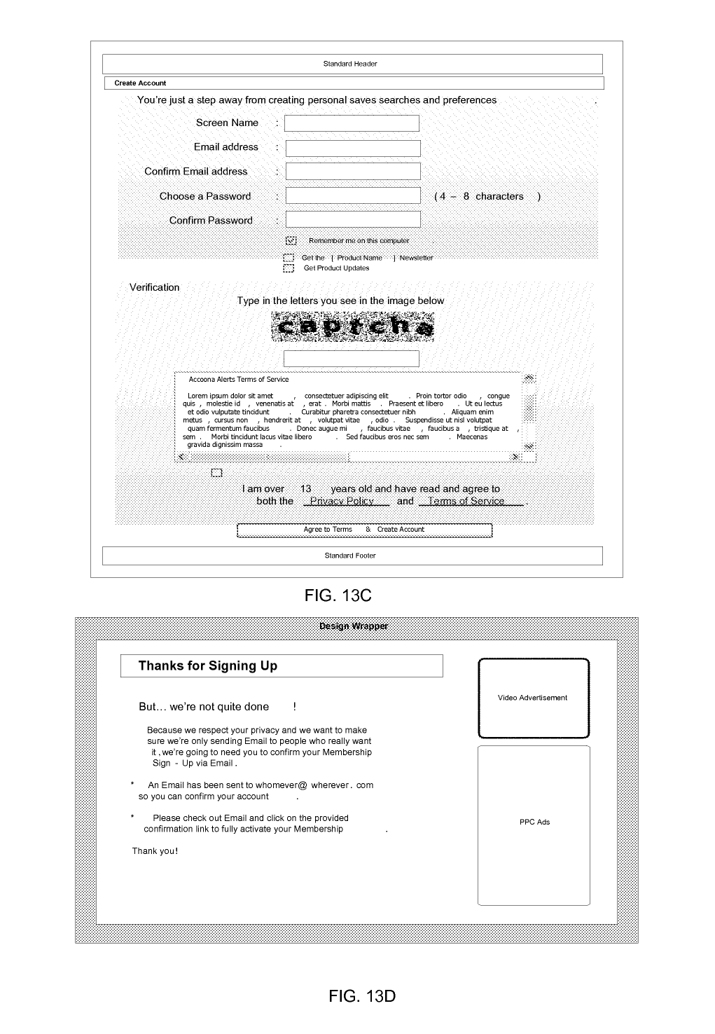

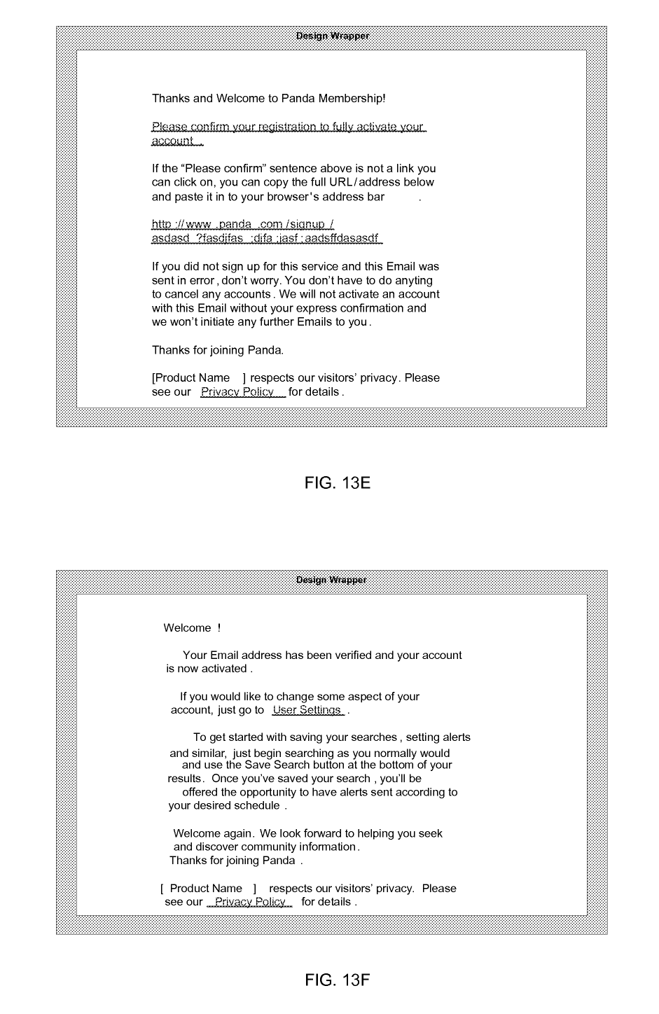

FIGS. 13A-13E provide example screen shots illustrating aspects of user sign-up for an embodiment of the FFS. In one embodiment, a user may be prompted to sign-up and/or log in to access certain features of the FFS, such as customized settings, access to particular forum search results, search history, etc. In one embodiment, the FFS may collect relevant user information (e.g., name/identifier, email address, account password and/or the like) and verify the new user. The FFS may also assist users who have forgotten their login and/or password.

FIG. 14A provides an example screenshot illustrating aspects of the FFS for saving forum search. In the embodiment shown, the provided interface allows a user to save searches and/or access, manage, edit and/or search/review saved searches. The interface may also allow a user to set up and manage alerts. In one implementation, alerts are configured to provide new forum content of interest to users. FIG. 14B provides an example alert interface for an implementation of the FFS. Using the alert interface, a user may select to continue a particular search at some periodicity such that new forum content (e.g., posts) that are subsequently ferreted by the FFS are identified for the user. The user may select a notification method (e.g., via email and/or feed), frequency (e.g., every week) and/or specify the amount provided for newly identified forum content. Depending on the implementation, when forum content is ferreted/re-ferreted, the FFS may update pointers in users' saved searches and/or alerts.

FIG. 14C provides an example screenshot illustrating aspects of a user engagement interface for an embodiment of the FFS. In the embodiment shown in the figure, the user engagement interface may provide forum insights, news and/or views encouraging user to explore and interact with the FFS. The FFS may tailor the engagement interface based on search patterns and/or history, viewed forum data, other user behavior, user preferences and/or like information. The engagement interface may include the modules shown (i.e., most linked from forums, hot topics, hot keywords, top forums, activity landscape, etc.) and/or other modules, and modules may be added and/or removed based on FFS setting and/or user preferences, and certain modules or elements of modules may be screened or filtered depending on the user or users (e.g., words shown by the hot keywords module may be filtered to not show adult language to a particular user). Some embodiments may allow users to scope the information provided by the engagement interface according to channels and/or other criteria (e.g., dates, media, etc.).

FIG. 14D provides an example screenshot illustrating aspects of a user engagement interface for another embodiment of the FFS.

### Directory

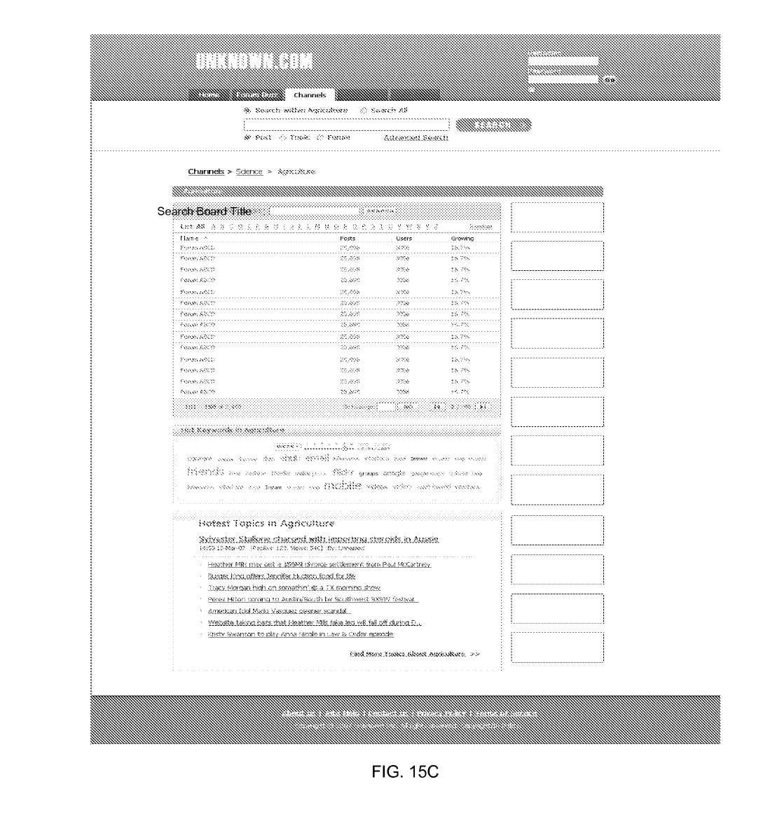

In one embodiment of the FFS, the FFS may create and maintain a forum directory. As such, the FFS may generate an initial directory taxonomy. Different implementations may utilize different types and complexities of taxonomies. For example, in one embodiment, the taxonomy may be structured such that nodes are exclusive to a parent, e.g., a category such as “fitness” would exist under “health” but not under “recreation,” while in another embodiment nodes may have multiple parents. The FFS may assign boards and/or forums to some specified number of taxonomy nodes. The assignment to nodes may be made by the FFS and/or by FFS administrators. In one embodiment, a human-readable URL may be provided to help users in taxonomic drill-down (e.g., http://productname/dir/arts/television/drama, but not http://productname/dir/cat?id=343434). FIGS. 15A-15C provide example taxonomy interfaces illustrating a first, second, and third level of taxonomy, respectively, for an embodiment of the FFS.

### Settings/Preferences

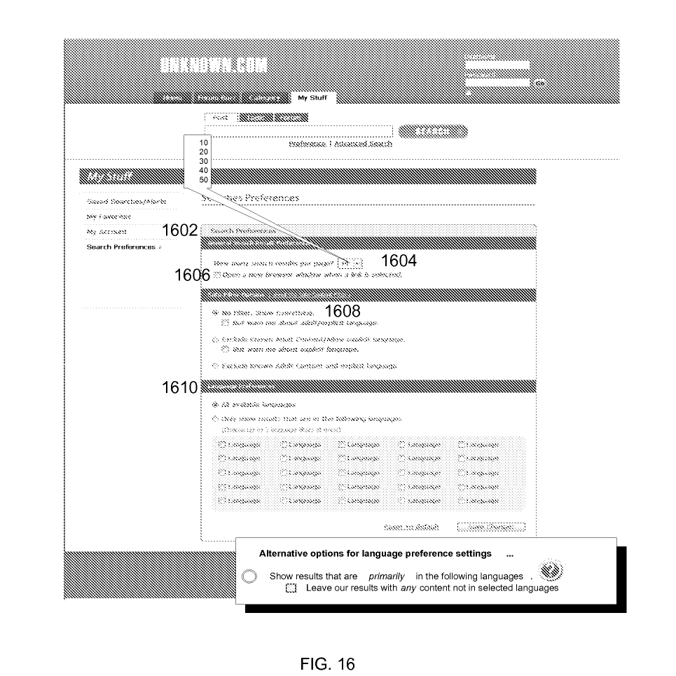

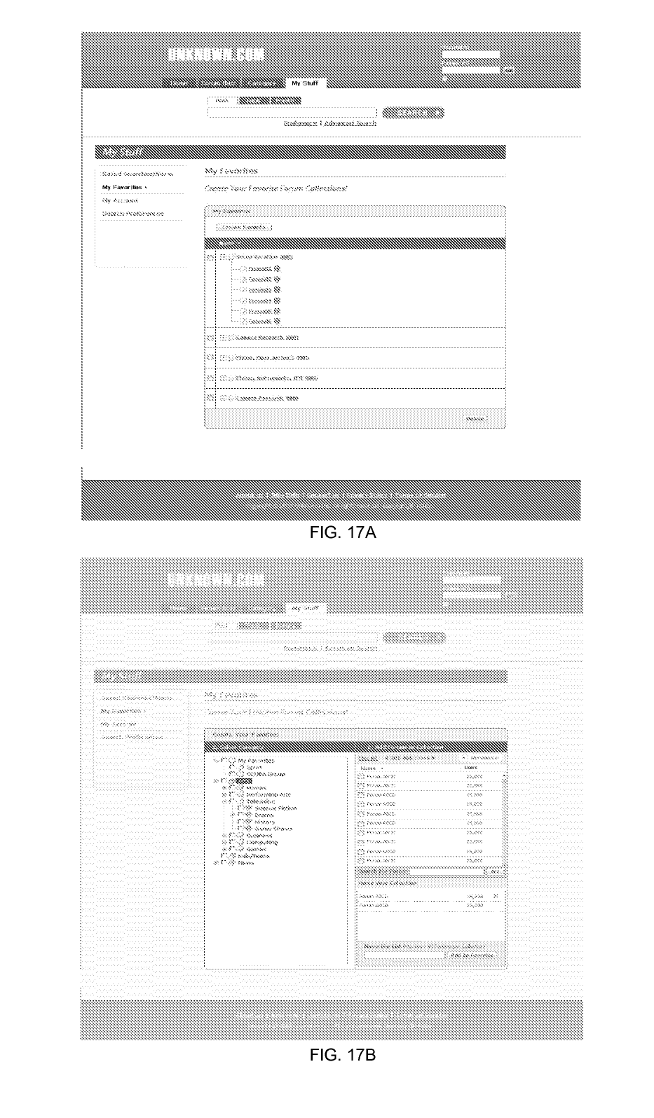

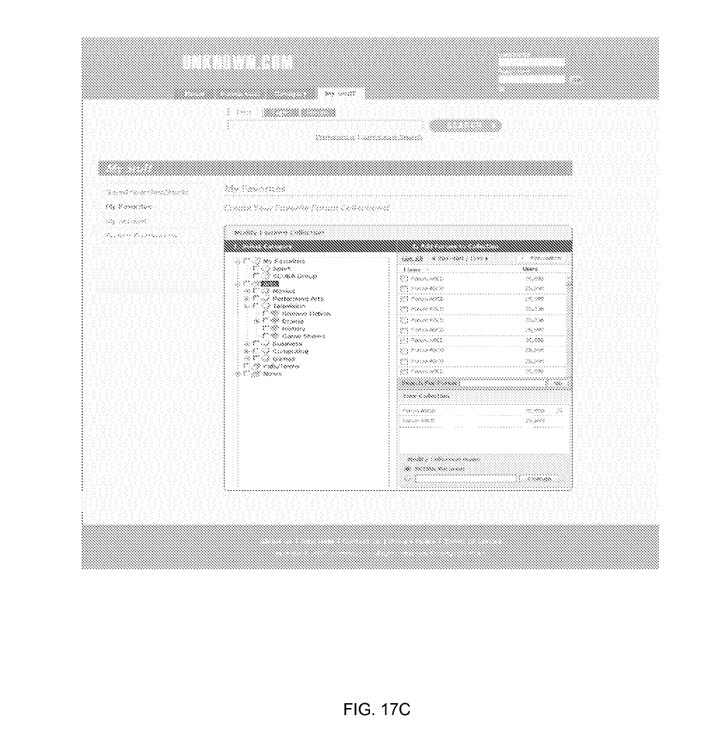

In some embodiments, user forum search settings and/or preferences may control aspects of the interfaces provided to users (e.g., display of forum search results). FIG. 16 provides an example setting/preferences interface for an embodiment of the FFS. As shown in the figure, user forum search preferences 1602 may include, but are not limited to, the number of forum search results per page 1604, whether a new browser window or tab is opened upon selecting results 1606, the selection and activation of filters 1608, language preference(s) 1610, and/or the like. In one embodiment, additional preferences may include the grouping of forum results (e.g., show the most relevant post or show all posts in the thread, specify the number of results per forum, show threads matching search, show forums matching search, etc.), location preference, and/or the like.

FIGS. 17A-17C provide example user favorites management interfaces for an embodiment of the FFS. The favorites management interfaces may allow users to create collections of the favorite forums, scope forum search results, create web page widgets, and/or the like.

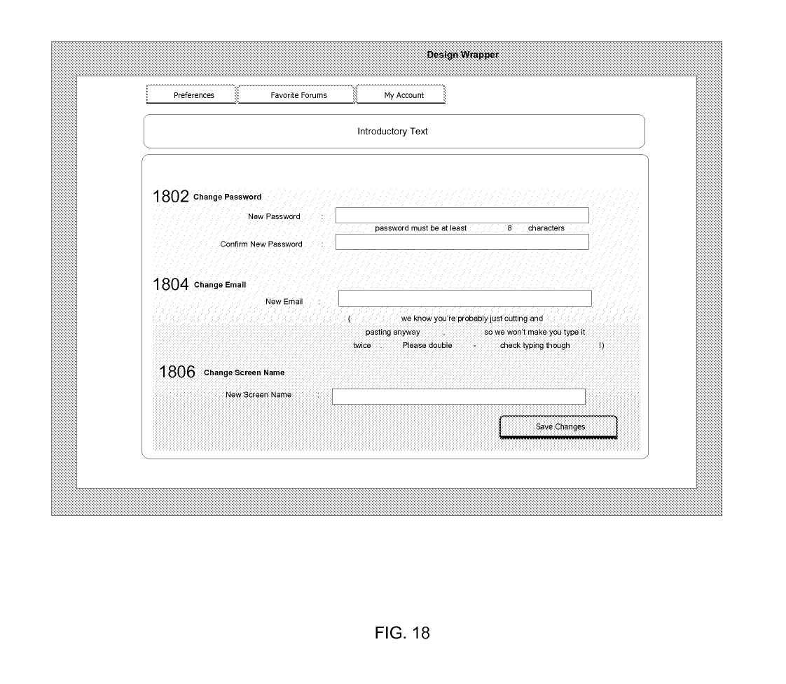

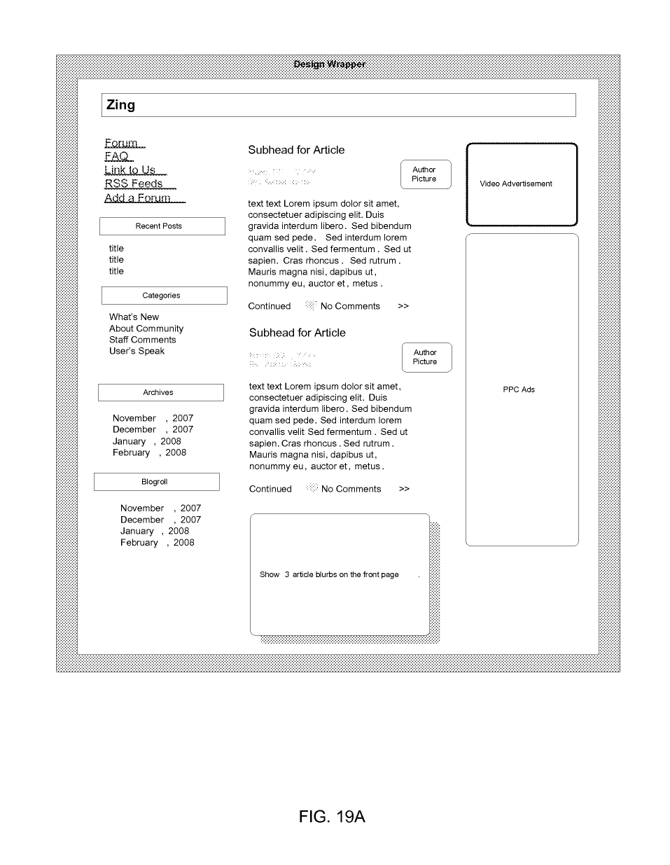

FIG. 18 provides an example user account modification interface for an embodiment of the FFS. The user account modification interface allows a user to modify his or her subscription and log in information, including changing password 1802, email 1804, screen name 1806, and/or the like.

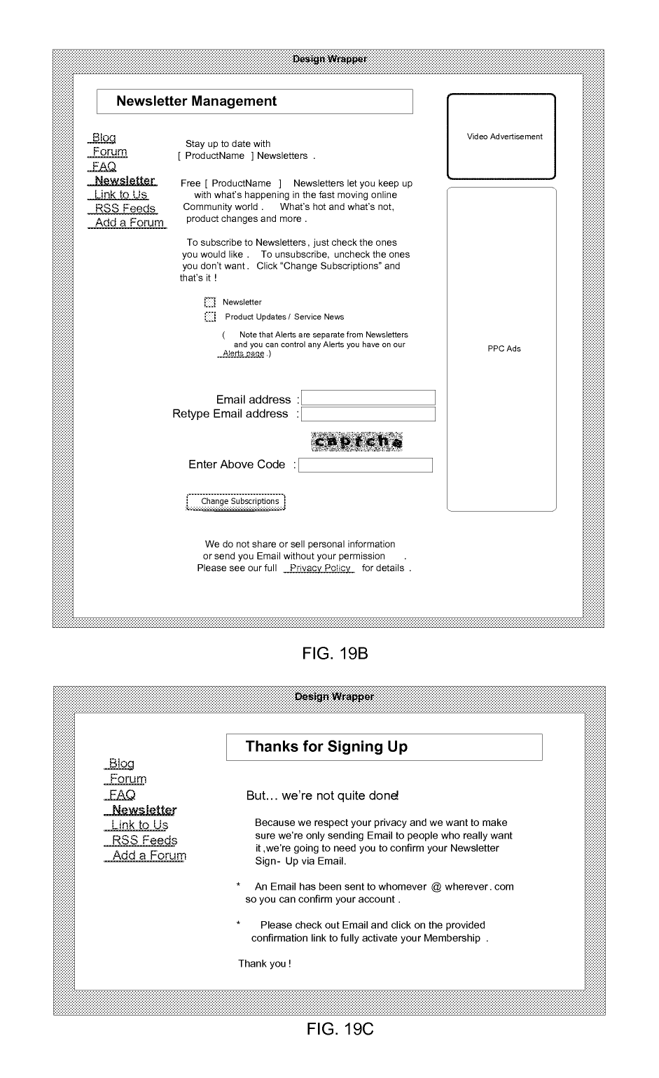

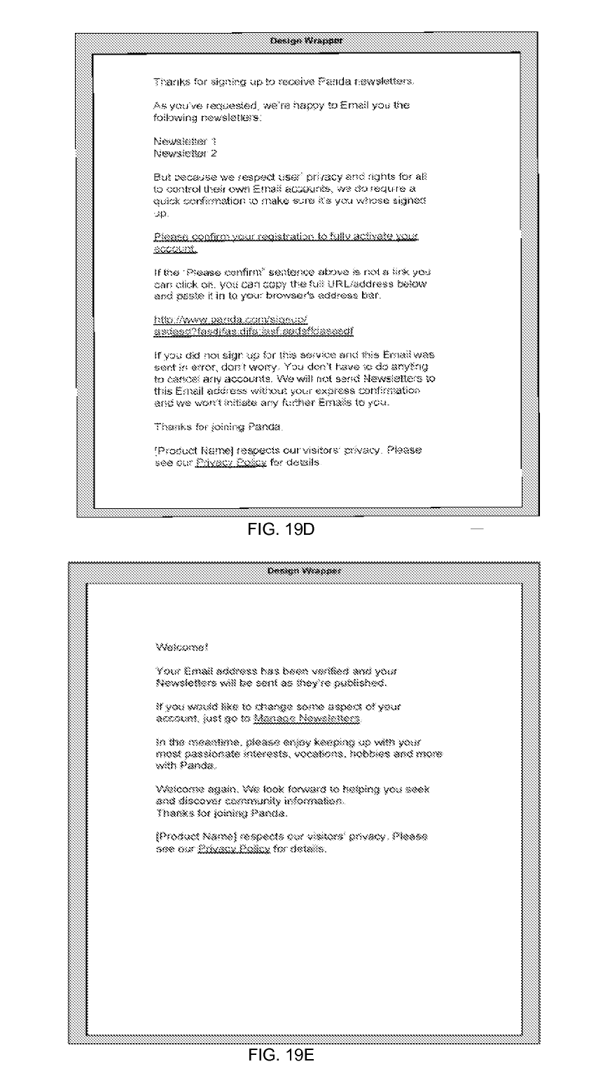

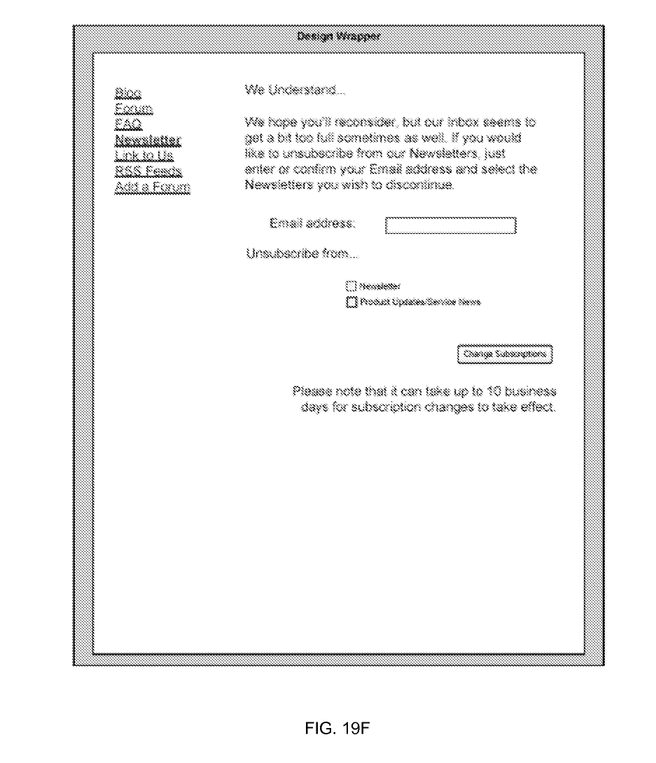

In some embodiments, the FFS may provide a user and/or customer update/information interface (e.g., blog or the like). Such an interface may include information on using the FFS, one or more online communities or forums, new features of the FFS, favorite/interesting forums and/or search results, etc. The FFS may alternatively or additionally provide a user and/or customer forum to communicate with users/customers of the FFS. In one embodiment, the FFS may also support a FFS-associated newsletter to inform and communicate with users. FIG. 19A illustrates an example newsletter template for an embodiment of the FFS. An FFS-associated newsletter may include new information/developments regarding the FFS, top 10 (or other number) topics from the previous period (e.g., week, month, etc.), top key phrases from previous period, seasonal topic spotlight (e.g., holidays, summertime/wintertime, etc.), news topic spotlights, company spotlights, recently added forums, and/or the like. FIGS. 19B-F provide example FFS-associated newsletter user-management interfaces for an embodiment of FFS.

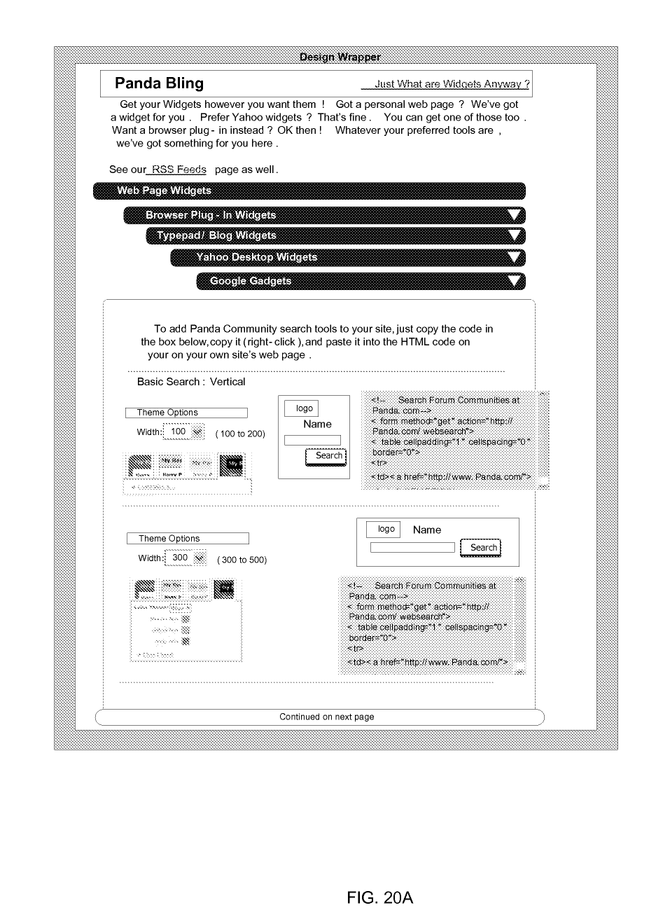

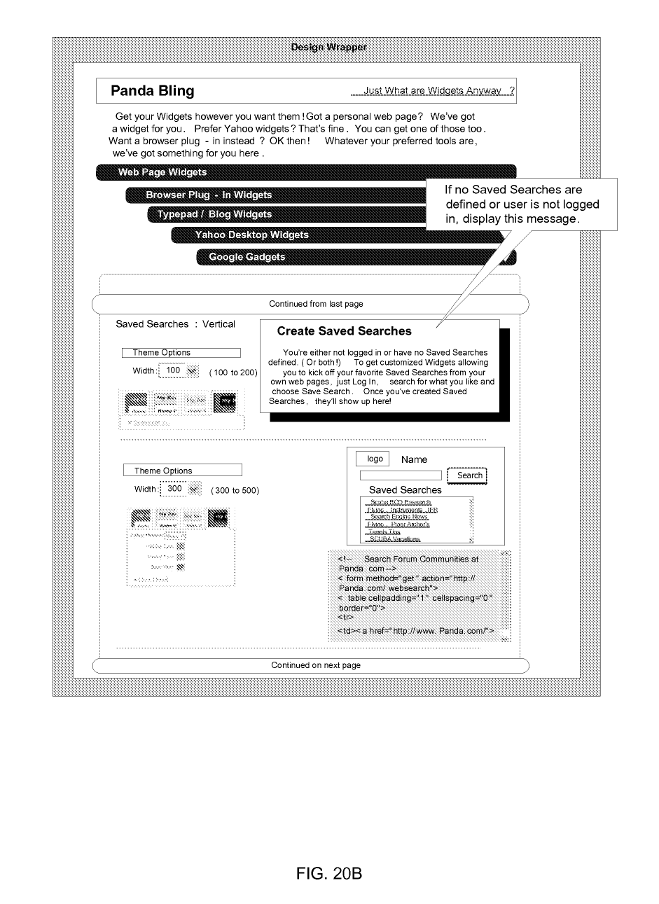

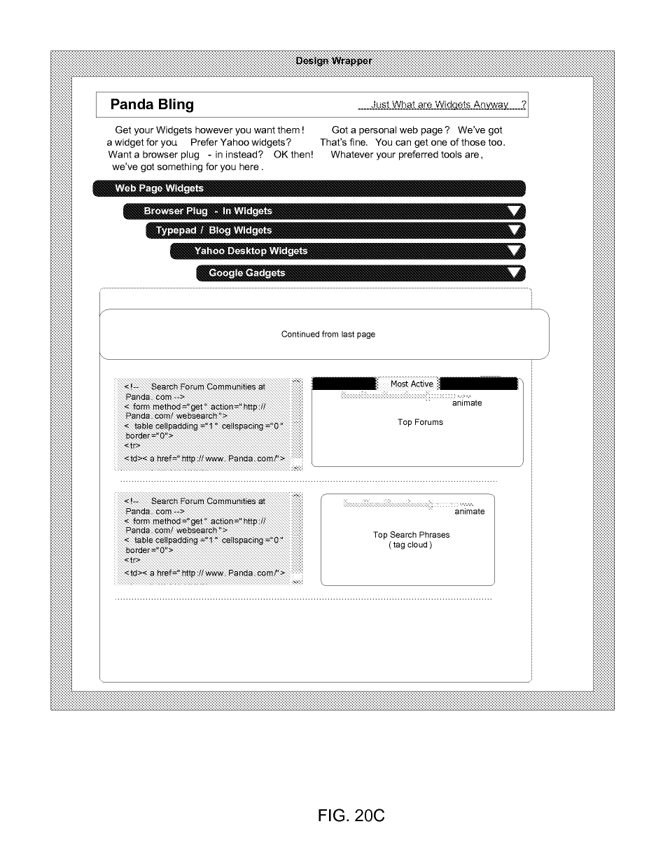

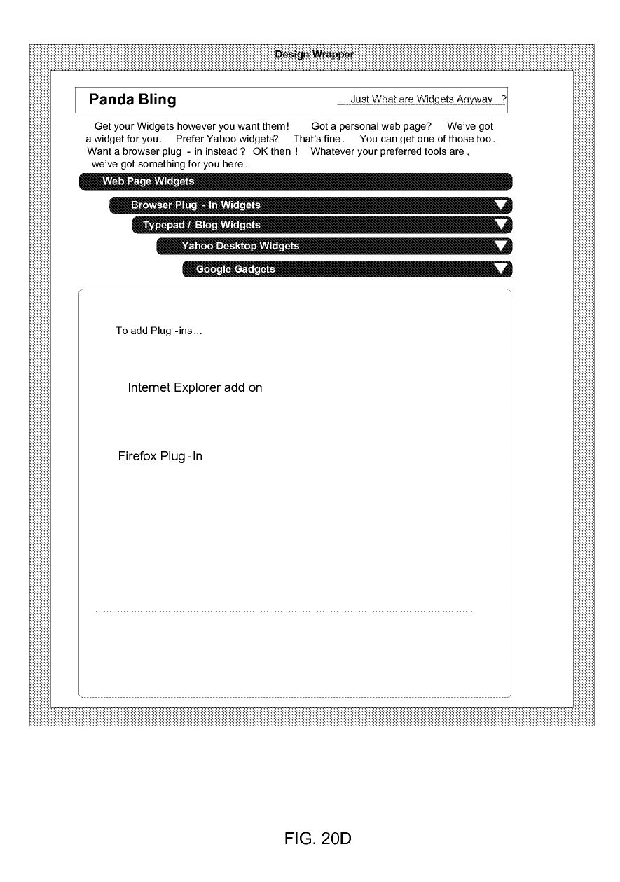

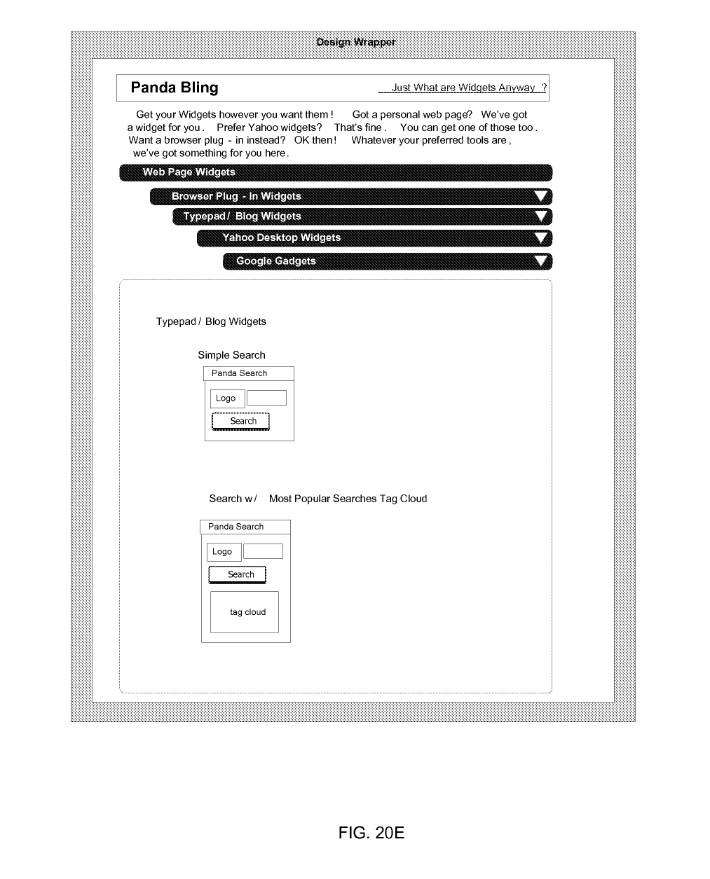

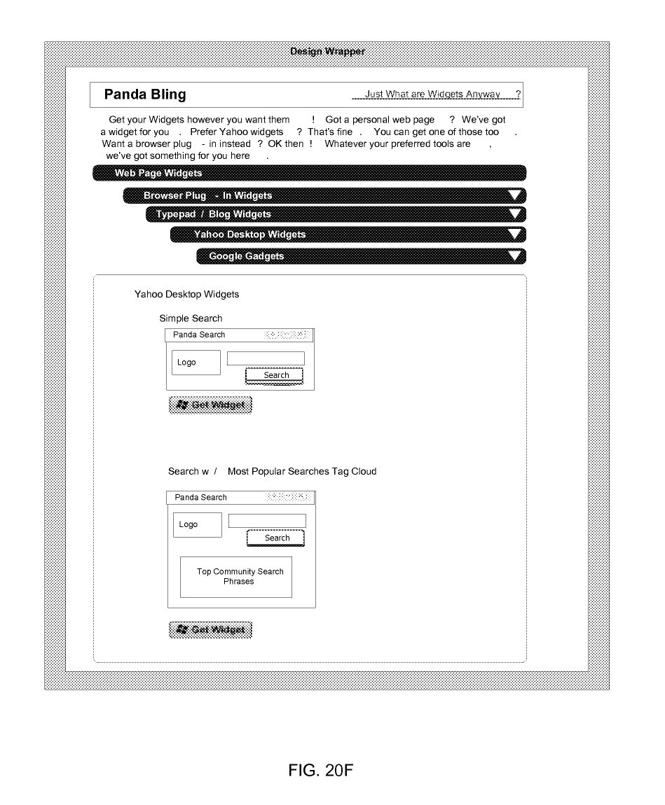

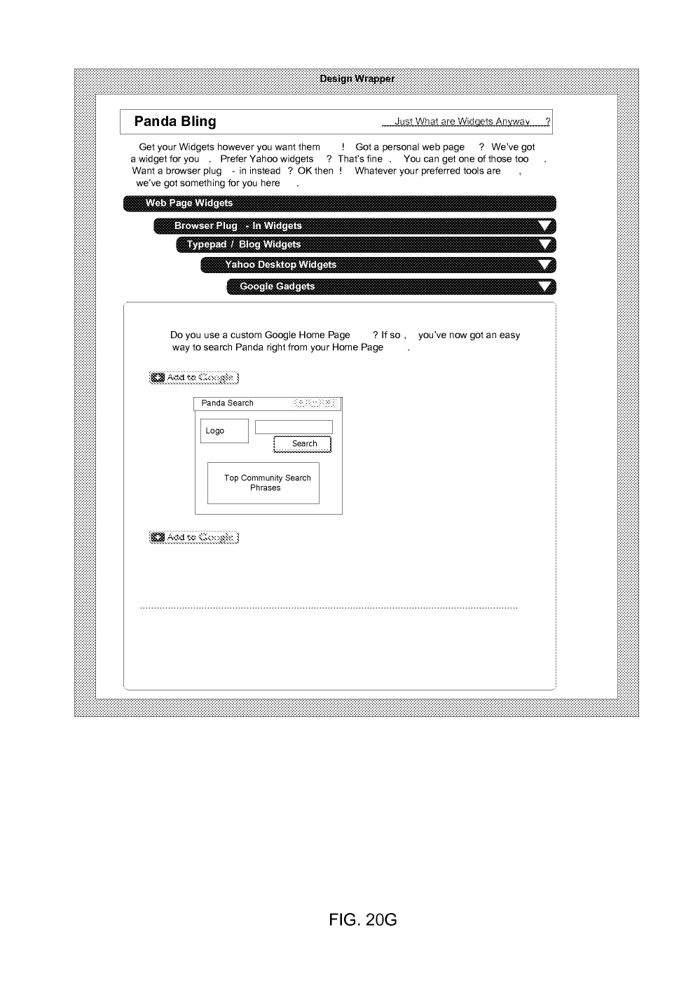

In one embodiment, the FFS may utilize client-side web application and/or small, self-contained features embedded in web pages to engage users. Users may be provided with graphics, code snippets, and various tools allowing them to link to the FFS and/or associated sites or services without requiring a formal relationship. In some embodiments, these tools may include widgets. Widgets may be made available to webpages/webpage-owners, as browser plug-ins or add-ons, as desktop or homepage widgets, and/or the like. For example, widgets may provide buttons/banners/microbanners that link to the FFS or associated sites, a simple search of FFS forum collection, a favorite search feature that allows users to define a set of forums to search, forum buzz widgets (e.g., top forums, top topics, top searches, etc.), and/or the like. FIGS. 20A-20G provide example interfaces illustrating aspects of FFS widgets and tools for some embodiments of the FFS.

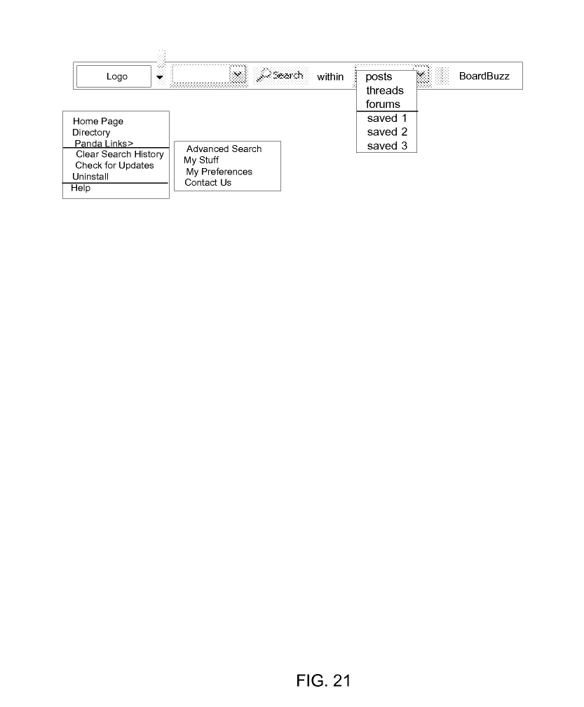

In one embodiment, the FFS may provide an FFS toolbar, which users may utilize to access a homepage, directory, links, forum search history, check for updates, install/uninstall tools or features (including the toolbar itself), help, and/or the like. The toolbar may also provide a basic search box with options to search by posts, threads, forums, user-defined saved searches, and/or the like. In some embodiments, the FFS may track toolbar usage, globally and/or specific to particular users. For example, the FFS may track number of installs/uninstalls, number of unique users, number of searches, number of clicks on toolbar and/or associated buttons, how a particular instance of the toolbar was acquired, and/or the like. FIG. 21 provides an example toolbar illustrating some of the features for an embodiment of the FFS.

In some embodiments, the FFS may provide feeds to users. In one embodiment, the FFS provides users with feeds based on topics, and feed topics may be specific to particular taxonomic categories. For example, a most-clicked topic(s) may exist for all topics, but may also be broken down by category. FIG. 22 provides an example feed interface for an embodiment of the FFS.

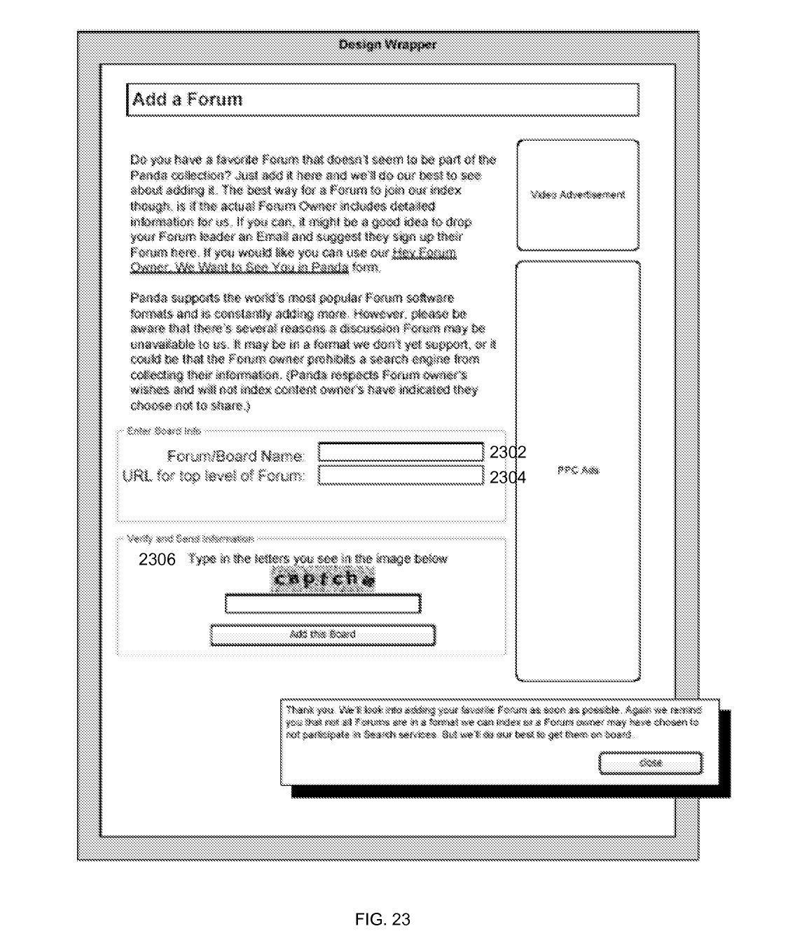

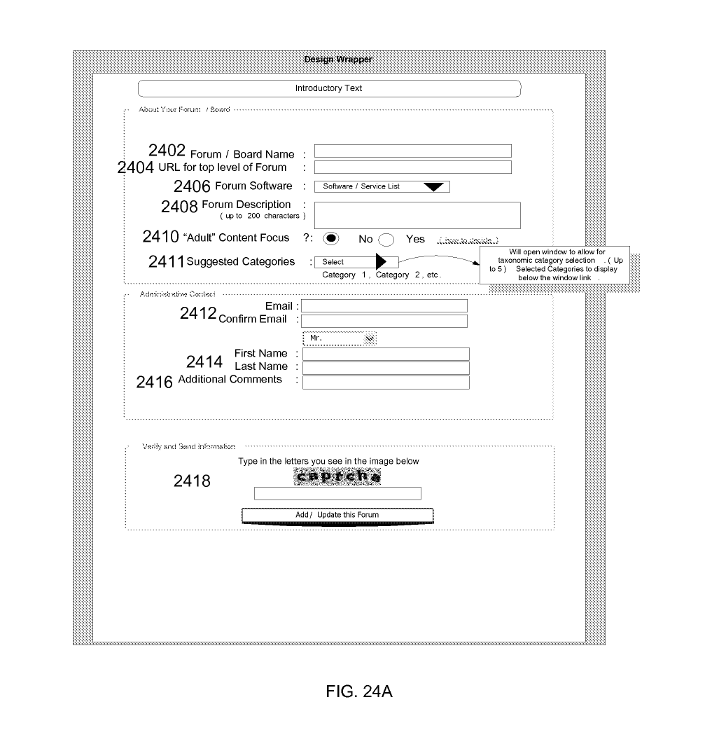

In some embodiments, the FFS may allow users to add a forum to the directory. FIG. 23 provides an example user interface provided by the FFS for receiving user submissions. A user may have less information regarding the forum than a forum owner would have, but some information may still be collected from the user, for example, the name of the forum 2302, starting URL 2304, and/or the like. In some embodiments, a submitting user may have to complete a CAPTCHA/Gimpy challenge 2306 or the like.

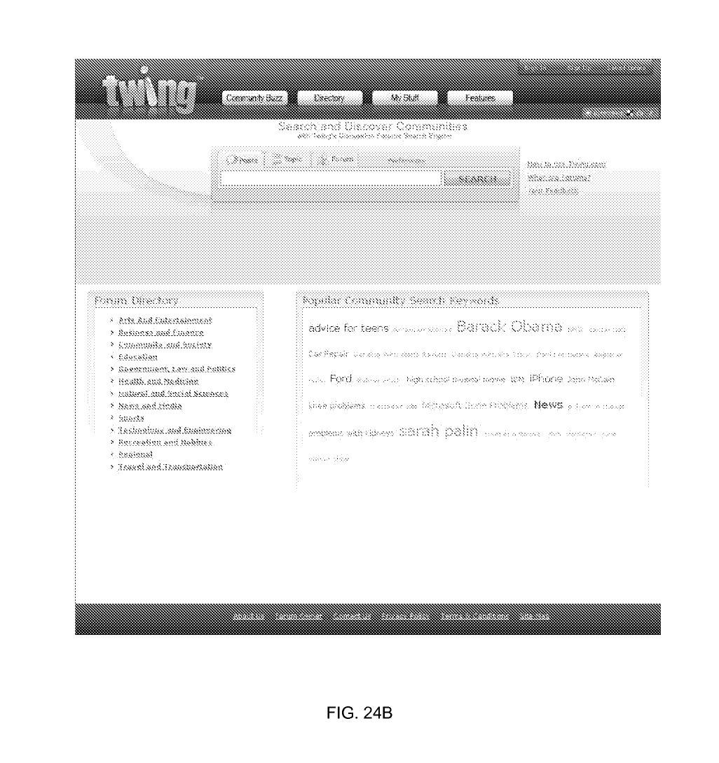

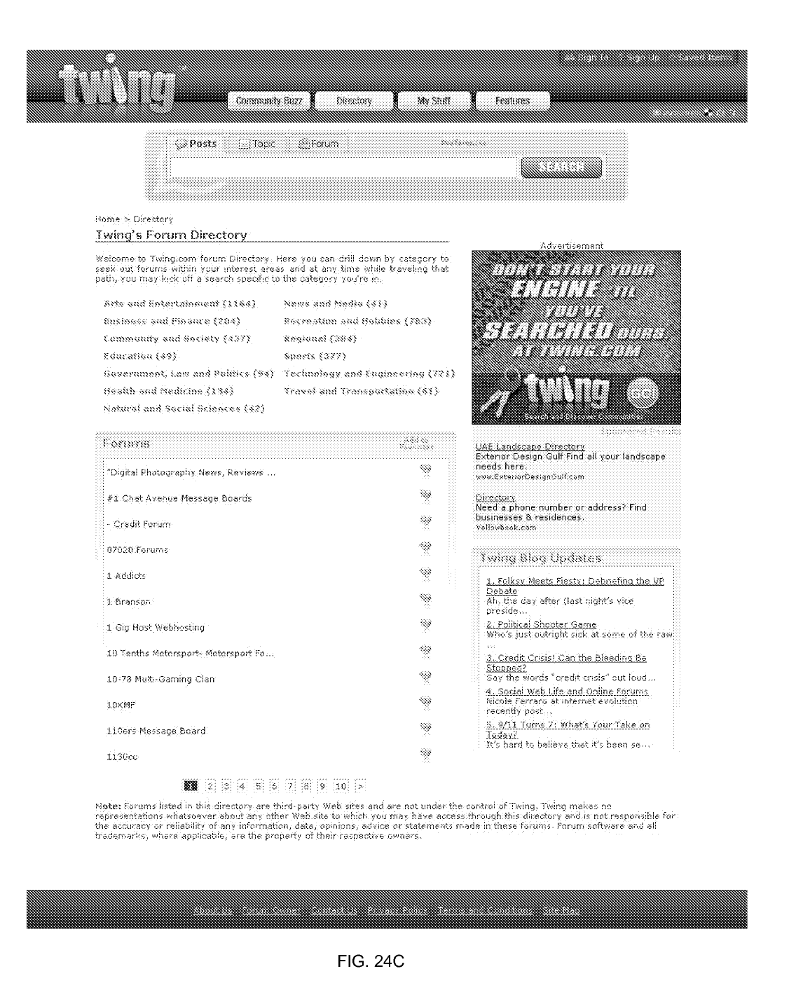

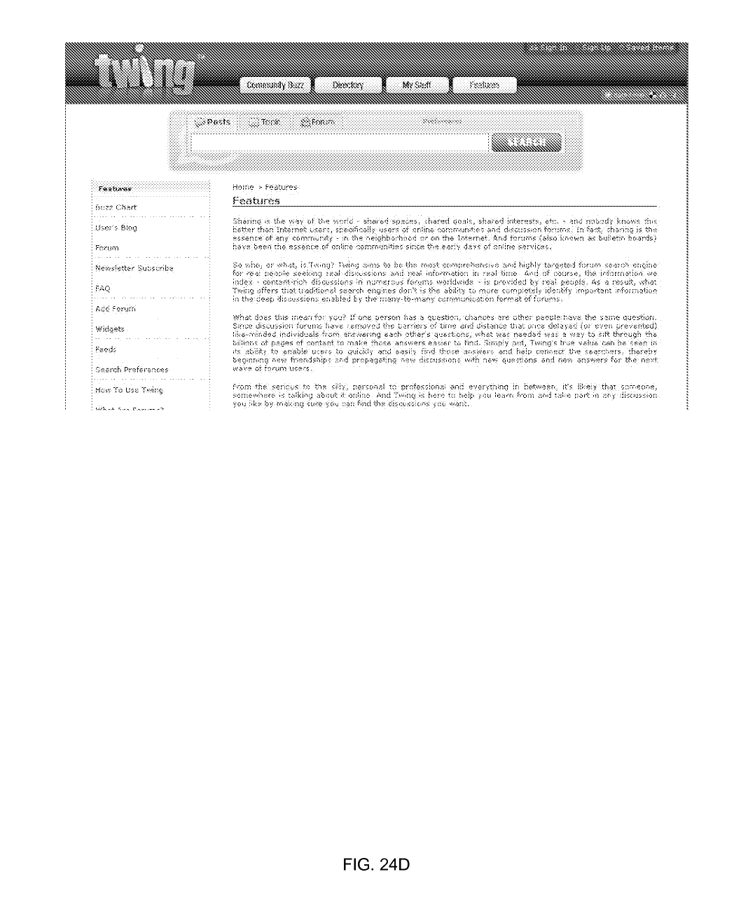

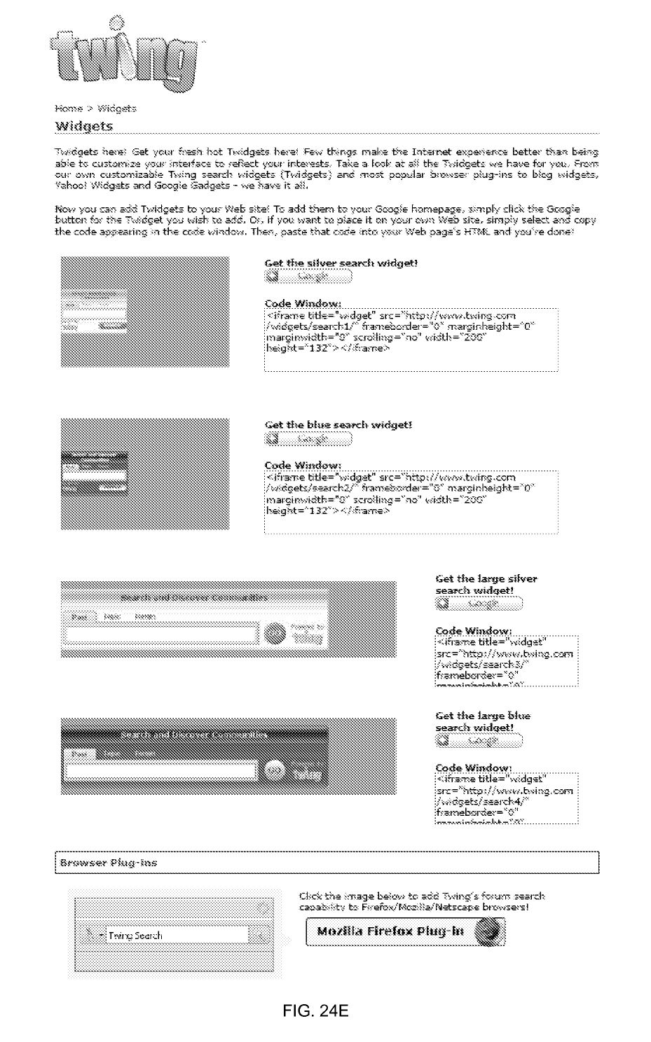

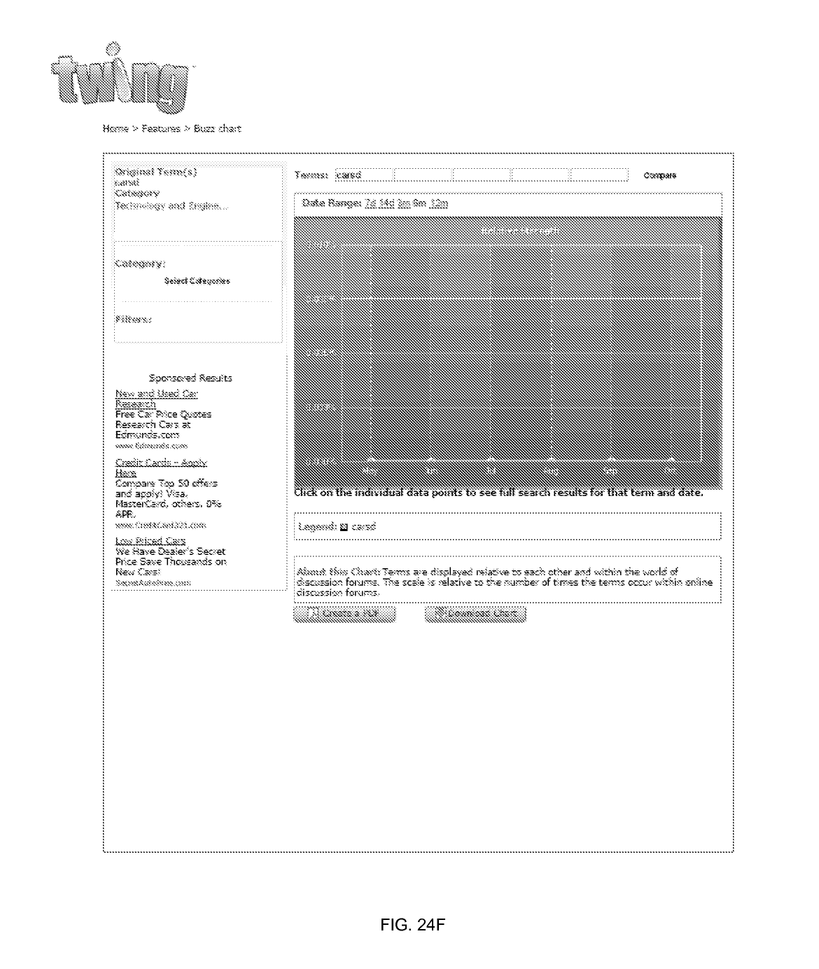

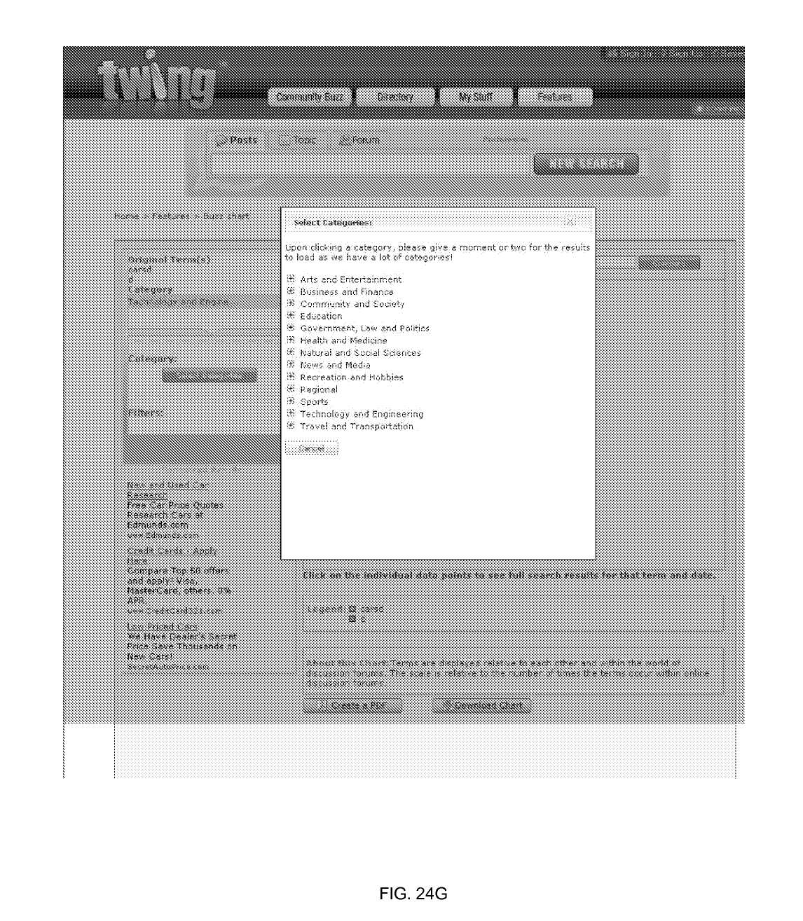

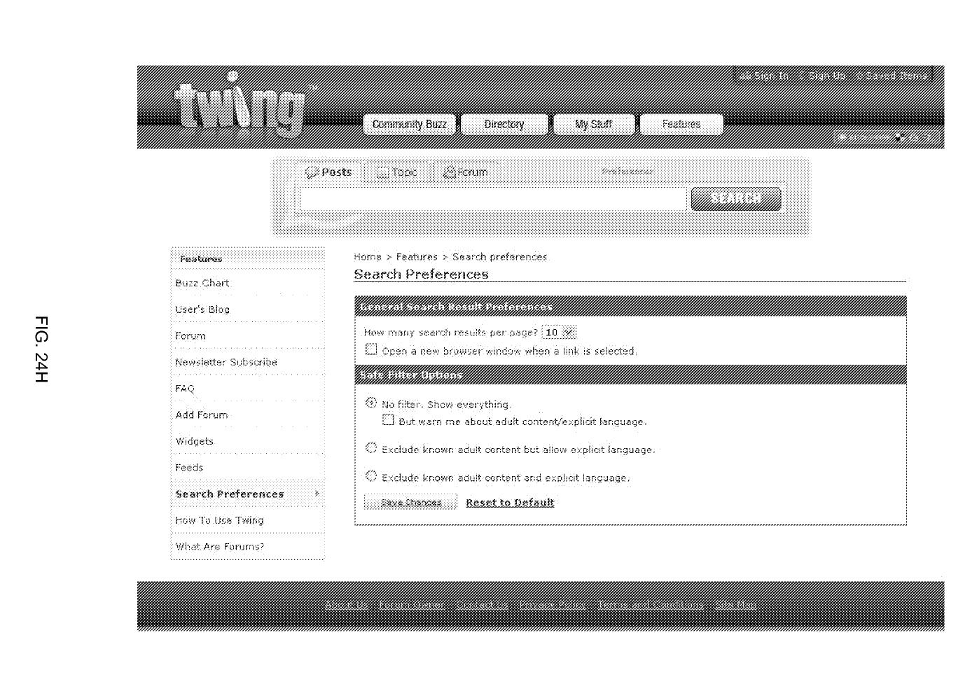

As discussed previously, the FFS may allow forum owners to submit their board to the FFS for ferreting and indexing. FIG. 24A provides an example interface provided by the FFS to allow forum owners to submit their forums. The FFS may collect relevant information from the forum owner, including, but not limited to: forum/board name 2402, URL for top level of forum 2404, software used 2406, forum description 2408, adult content/focus information 2410, suggested categories 2411, email address 2412, contact person's name 2414, additional comments 2416, and/or the like. In some embodiments, the interface may also have a CAPTCHA/Gimpy challenge 2418 or like verification measure. Other information may also be received, including information for multi-forum submissions, forum/site categorization/taxonomy, geographic location, advanced information, additional description, ferreting frequency (including time of day), and/or the like. The FFS may also provide forum owners with additional interfaces for subsequent management of submitted information and the relationship between the FFS and their forums. FIGS. 24B-24H provide additional example interfaces for embodiments of the FFS.

In further embodiments of the FFS, forum search options/tools may include some or all of the following: typeahead dictionary help for when user is entering query terms (including standard word dictionaries and/or prior user query data to help populate lists); visual term boosting allowing users to modify value of key forum search terms for relevancy purposes using easy to figure out and implement visual tools; visual navigator boosting that allows users modify the relevancy value of various navigator selections using visual tools; visual boost tools (e.g., pie charts with handles for adjusting pie slices, horizontal bars adding to 100% that allow individual segments to be adjusted, and/or like visual mechanisms for relevancy boosting); and/or the like. In some embodiments, the FFS may allow for forum search by user ratings (e.g., based on ratings of forums, thread, posts). In another embodiment the FFS may provide a “find similar” feature or tool allowing a user to find a post, thread, or forum similar to a displayed post, thread, or forum.

In some embodiment, the FFS may provide for multimedia search within a community with a forum search tool targeting multimedia items. Depending on the implementation, such a tool may be directed toward and/or may distinguish multimedia based on type. For example, the FFS may distinguish between embedded media (e.g., graphic embedded in a forum post that is viewable when a user looks at the post), attached media (e.g., a media object attached to a post), or linked media (e.g., hypertext link to a media object).

Some embodiments of the FFS may include visualizations with the forum directory. For example, one implementation may utilize tree maps to show forums' taxonomic relationship to each other, while another embodiment may use “heat” maps to show relative post volume activity over time for each category, while still other embodiments may show the “feelings” or sentiments associated with various categories.

In another embodiment of the FFS, keyword trends may be displayed. For example, keyword trends may be shown in a graph format. That is, when user enters keywords, the keywords' incidence over time, (past week, past month, etc.) may be displayed.

Some embodiments may also provide directory enhancement via category cross-reference. Such embodiments may allow users to drill down into any category that makes the most sense from their perspective, as opposed to an arbitrarily chosen single hierarchy. That is, even though a forum may be listed under multiple nodes, the nodes themselves may not wholly reflect all users' mental models or views of the world, and the FFS may be configured to reflect such situations.

### Forum Ferreting System Controller

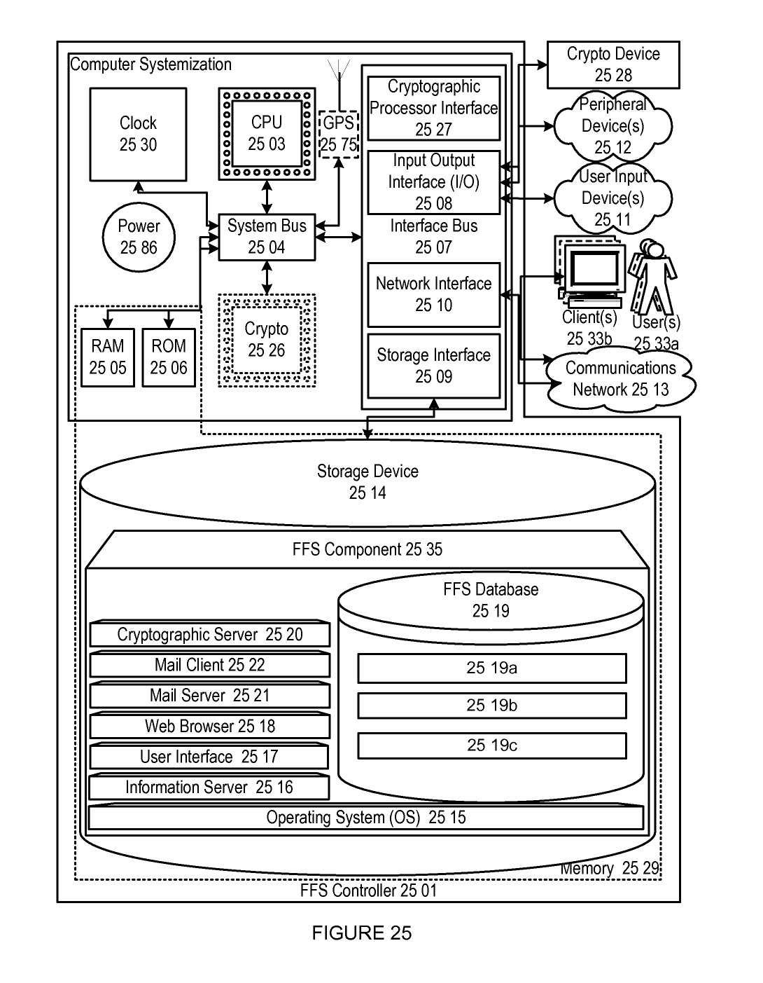

FIG. 25 of the present disclosure illustrates inventive aspects of a forum ferreting system (FFS) controller 2501 in a block diagram. In this embodiment, the FFS controller 2501 may serve to aggregate, process, store, search, serve, identify, instruct, generate, match, and/or update databases, database elements, database element fields, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the FFS controller 2501 may be connected to and/or communicate with entities such as, but not limited to: one or more users from user input devices 2511; peripheral devices 2512; a cryptographic processor device 2528; and/or a communications network 2513.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The FFS controller 2501 may be based on common computer systems that may comprise, but are not limited to, components such as: a computer systemization 2502 connected to memory 2529.

Computer Systemization

A computer systemization 2502 may comprise a clock 2530, central processing unit (CPU) 2503, a read only memory (ROM) 2506, a random access memory (RAM) 2505, and/or an interface bus 2507, and most frequently, although not necessarily, are all interconnected and/or communicating through a system bus 2504. Optionally, the computer systemization may be connected to an internal power source 2586. Optionally, a cryptographic processor 2526 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying info, throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the FFS controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 2586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2586 is connected to at least one of the interconnected subsequent components of the System thereby providing an electric current to all subsequent components. In one example, the power source 2586 is connected to the system bus component 2504. In an alternative embodiment, an outside power source 2586 is provided through a connection across the I/O 2508 interface. For example, a USB and/or IEEE 1394 connection carries both data and power across the connection and is therefore a suitable source of power.

Interface Adapters

Interface bus(es) 2507 may accept, connect, and/or communicate to a number of interface adapters, conventionally although not necessarily in the form of adapter cards, such as but not limited to: input output interfaces (I/O) 2508, storage interfaces 2509, network interfaces 2510, and/or the like. Optionally, cryptographic processor interfaces 2527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2509 may accept, communicate, and/or connect to a number of storage devices such as, but not limited to: storage devices 2514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2510 may accept, communicate, and/or connect to a communications network 2513. Through a communications network 113, the FFS controller is accessible through remote clients 2533b (e.g., computers with web browsers) by users 2533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2510 may be used to engage with various communications network types 2513. For example, multiple network interfaces may be employed to allow for the communication over broadcast, multicast, and/or unicast networks.

Input Output interfaces (I/O) 2508 may accept, communicate, and/or connect to user input devices 2511, peripheral devices 2512, cryptographic processor devices 2528, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 2511 may be card readers, dongles, finger print readers, gloves, graphics tablets, joysticks, keyboards, mouse (mice), remote controls, retina readers, trackballs, trackpads, and/or the like.

Peripheral devices 2512 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the FFS controller may be embodied as an embedded, dedicated, and/or monitor-less (i.e., headless) device, wherein access would be provided over a network interface connection.

Cryptographic units such as, but not limited to, microcontrollers, processors 2526, interfaces 2527, and/or devices 2528 may be attached, and/or communicate with the FFS controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 2529. However, memory is a fungible technology and resource, thus, any number of memory embodiments may be employed in lieu of or in concert with one another. It is to be understood that the FFS controller and/or a computer systemization may employ various forms of memory 2529. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 2529 will include ROM 2506, RAM 2505, and a storage device 2514. A storage device 2514 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 2529 may contain a collection of program and/or database components and/or data such as, but not limited to: operating system component(s) 2515 (operating system); information server component(s) 2516 (information server); user interface component(s) 2517 (user interface); Web browser component(s) 2518 (Web browser); database(s) 2519; mail server component(s) 2521; mail client component(s) 2522; cryptographic server component(s) 2520 (cryptographic server); the FFS component(s) 2535; and/or the like (i.e., collectively a component collection). These components may be stored and accessed from the storage devices and/or from storage devices accessible through an interface bus. Although non-conventional program components such as those in the component collection, typically, are stored in a local storage device 2514, they may also be loaded and/or stored in memory such as: peripheral devices, RAM, remote storage facilities through a communications network, ROM, various forms of memory, and/or the like.

Operating System

The operating system component 2515 is an executable program component facilitating the operation of the FFS controller. Typically, the operating system facilitates access of I/O, network interfaces, peripheral devices, storage devices, and/or the like. The operating system may be a highly fault tolerant, scalable, and secure system such as: Apple Macintosh OS X (Server), Linux, AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the FFS controller to communicate with other entities through a communications network 2513. Various communication protocols may be used by the FFS controller as a subcarrier transport mechanism for interaction, such as, but not limited to: multicast, TCP/IP, UDP, unicast, and/or the like.

Information Server

An information server component 2516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, Java, JavaScript, Practical Extraction Report Language (PERL), Hypertext Pre-Processor (PHP), pipes, Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the FFS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the System database 2519, operating systems, other program components, user interfaces, Web browsers, and/or the like.

Access to the System database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the System. In one embodiment, the information server would provide a Web form accessible by a Web browser. Entries made into supplied fields in the Web form are tagged as having been entered into the particular fields, and parsed as such. The entered Mins are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the System as a query. Upon generating query results from the query, the results are passed over the bridge mechanism, and may be parsed for formatting and generation of new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, strollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/Vista (i.e., Aero)/XP, or Unix's X-Windows (e.g., which may include additional Unix graphic interface libraries and layers such as K Desktop Environment (KDE), mythTV and GNU Network Object Model Environment (GNOME)), provide a baseline and means of accessing and displaying information graphically to users.

A user interface component 2517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 2518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the System enabled nodes. The combined application may be nugatory on systems employing standard Web browsers.

Mail Server

A mail server component 2521 is a stored program component that is executed by a CPU 2503. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++),C# and/or .NET, CGI scripts, Java, JavaScript, PERL, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the System.

Access to the System mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 2522 is a stored program component that is executed by a CPU 2503. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 2520 is a stored program component that is executed by a CPU 2503, cryptographic processor 2526, cryptographic processor interface 2527, cryptographic processor device 2528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir,and Leonard Adleman), Secure Hash Algorithm (SHA), Secure Socket Layer (SSL), Secure Hypertext Transfer Protocol (HTTPS), and/or the like. Employing such encryption security protocols, the System may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the System component to engage in secure transactions if so desired. The cryptographic component facilitates the secure accessing of resources on the System and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The FFS Database

The FFS database component 2519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the FFS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the System database is implemented as a data-structure, the use of the System database 2519 may be integrated into another component such as the FFS component 2535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2519 includes several tables 2519a-119c. These and/or other tables may facilitate, support and/or track forum searching and/or navigation on the FFS controller. A records table 2519a includes fields such as, but not limited to: record_id, forum_data, board_data, thread_data, post_data, content_data, account_data, author_data, board_stats_data, post_stats_data, analysis_data and/or the like. An accounts table 2519b includes fields such as, but not limited to: account_id, account_data, forum_owner_data, forum_owner_preferences, user_account_data, user_preferences, user_history, and/or the like. A filters table 2519c includes fields such as, but not limited to: filter_id, offensive_filter, adultcontent_filter, legal_filter, other_filter, filter_settings, and/or the like.

In one embodiment, the FFS database may interact with other database systems. For example, employing a distributed database system, queries and data access by System modules may treat the combination of the FFS database and another database as a single database entity.

In one embodiment, user programs may contain various user interface primitives, which may serve to update the FFS. Also, various accounts may require custom database tables depending upon the environments and the types of clients the System may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2519a-119c. The System may be configured to keep track of various settings, inputs, and parameters via database controllers.

The System database may communicate to and/or with other components in a component collection, including itself, and/or facilities of the like. Most frequently, the System database communicates with the System component, other program components, and/or the like. The database may contain, retain, and provide information regarding other nodes and data.

The FFS Component

The FFS component 2535 is a stored program component that is executed by a CPU. In one embodiment, the FFS component incorporates any and/or all combinations of the aspects of the FFS that were discussed in previous figures. As such, the FFS component affects accessing, obtaining and the provision of information, services, transactions, and/or the like across various communications networks. As such, the FFS component enables one to access, calculate, engage, exchange, generate, identify, instruct, match, process, search, serve, store, data and/or functionally enable a system user to search and/or navigate a variety of forums and/or forum information.

The FFS component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, WebObjects, and/or the like. In one embodiment, the FFS server employs a cryptographic server to encrypt and decrypt communications. The FFS component may communicate to and/or with other components in a component collection, including itself, and/or facilities of the like. Most frequently, the FFS component communicates with the FFS database, operating systems, other program components, and/or the like. The FFS may contain, communicate, generate, obtain, and/or provide program component, system, user, and/or data communications, requests, and/or responses.

Distributed System

The structure and/or operation of any of the FFS node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the FFS controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:

w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or other wise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. Again, the desired configuration will depend upon the context, environment, and requirements of system deployment. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, Appendices and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method for forum search comprising:
ferreting an at least one forum to collect forum data;
analyzing the collected forum data;
applying a filter to forum data based on the analysis of the collected forum data;
associating an index with the forum data, wherein the association of the index is based on the analysis of the collected forum data;
storing the associated index in a searchable database;
receiving and processing a forum data query; and
returning relevant forum data.

2. A processor-implemented method for forum ferreting, comprising:
receiving identification information for a forum;
associating the received identification information with a forum record,
wherein if the identification information indicates the forum is a previously identified forum, the received information is associated with an existing forum record for the previously identified forum,
wherein if the identification information indicates the forum is not an existing forum, a new forum record is created,
determining if the received information includes forum metadata,
wherein if the received information does include forum metadata the forum metadata is associated with the forum record;
determining forum accessibility information and associating forum accessibility information with the forum record,
wherein determining accessibility information includes determining if the forum is access-restricted,
wherein if the forum is access-restricted, determining whether access may be obtained,
wherein if access may be obtained, obtaining access to the forum;
ferreting the forum for forum data; and
updating the forum record with the forum data.

3. The method of claim 2, further comprising:
determining the difference between a current time and a last time the forum record was updated,
wherein if the difference between a current time and a last time time the forum record was updated is greater than a specified forum refresh period the forum is ferreted for new forum data,
wherein if new forum data is ferreted, updating the forum record with the new forum data.

4. The method of claim 2, further comprising:
determining a time of most recent forum activity for the forum;
determining a time for the most recent update of the forum record;
ferreting the forum for new forum data associated with recent activity on the forum if the time of most recent forum activity for the forum is after the time for the most recent update of the forum record; and
updating the record with new forum data associated with recent activity on the forum.

5. The method of claim 2, wherein the forum data includes thread data.

6. The method of claim 2, wherein the forum data includes post data.

7. The method of claim 6, wherein the post data includes media data.

8. The method of claim 7, wherein the media data includes embedded video data.

9. A processor-implemented method for ferreting one or more internet forums, comprising:
receiving identification for a forum to be ferreted;
determining if there are sub-forums associated with the forum;
analyzing the forum and any associated sub-forums, wherein analysis of the forum and any associated sub-forum includes identifying threads;
analyzing the threads to identify posts associated with each of the threads;
retrieving and indexing post data for posts associated with each of the threads;
associating the retrieved and indexed post data with a forum record,
wherein the forum record and associated information is stored in a searchable database.

10. The method of claim 9, wherein the identification for the forum includes forum URL data.

11. The method of claim 9, wherein analyzing the forum and any associated sub-forums to identify threads includes analyzing pages associated with the forum and any sub-forums to identify any URLs that fit a pattern of a thread URL.

12. The method of claim 9, further comprising:
determining the number of threads associated with the forum and any sub-forums.

13. The method of claim 12, further comprising:
determining the number of user views for each of the threads associated with the forum and any sub-forums.

14. The method of claim 12, further comprising:
determining the number of posts in each of the threads associated with the forum and any sub-forums.

15. The method of claim 14, further comprising:
determining the most recent post for each of the threads associated with the forum and any sub-forums.

16. The method of claim 9, wherein analysis of the forum and any associated sub-forum includes determining board statistics, wherein board statistics are associated with the forum record.

17. The method of claim 16, wherein board statistics includes the number of threads.

18. The method of claim 16, wherein board statistics includes the number of posts.

19. The method of claim 16, wherein board statistics includes the number of forum members.

20. The method of claim 9, wherein analysis of the forum and any associated sub-forum includes determining thread statistics, wherein thread statistics are associated with the forum record.

21. The method of claim 20, wherein thread statistics includes the number of posts for each thread.

22. The method of claim 20, wherein board statistics includes the number of views for each thread.

23. The method of claim 9, wherein analysis of the forum and any associated sub-forum includes determining post statistics, wherein post statistics are associated with the forum record.

24. The method of claim 23, wherein post statistics includes the number of responses to each post.

25. The method of claim 23, wherein post statistics includes author information for each post.

26. The method of claim 25, wherein author information includes author rating information.

27. The method of claim 23, wherein post statistics includes post rating information for each post.

28. The method of claim 23, wherein post statistics include post relevancy information for each post.

29. The method of claim 9, wherein the post data includes board identification information.

30. The method of claim 9, wherein the post data includes forum identification information.

31. The method of claim 9, wherein the post data includes thread identification information.

32. The method of claim 9, wherein the post data includes external post identification information.

33. The method of claim 9, wherein the post data includes post media information.

34. The method of claim 33, wherein the post media information includes embedded content information.

35. The method of claim 33, wherein the post media information includes image information.

36. The method of claim 33, wherein the post media information includes audio information.

37. The method of claim 33, wherein the post media information includes video information.

38. The method of claim 9, wherein the post data includes timestamp information.

39. The method of claim 9, wherein the post data includes author information.

40. The method of claim 9, wherein the post data includes title information.

41. The method of claim 9, wherein the post data includes body text information.

42. A processor-implemented method for providing relevant internet forum search results, comprising:
receiving an at least one search term from a forum-searching user;
generating and issuing a query to an at least one database of indexed forum records, wherein the query is based on the at least one search term;
receiving a selection of forum data from the at least one database in response to the query;
applying an at least one filter to the selection of forum data;
ordering the selection of forum data according to relevance; and
returning the filtered, ordered forum data to the forum-searching user.

43. The method of claim 42, wherein the forum data includes board data.

44. The method of claim 42, wherein the forum data includes thread data.

45. The method of claim 42, wherein the forum data includes post data.

46. The method of claim 42, wherein the at least one filter includes an adult content filter.

47. The method of claim 42, wherein the at least one filter includes an offensive content filter.

48. The method of claim 42, wherein the at least one filter includes a language filter.

49. The method of claim 42, wherein the at least one filter includes a legal filter.

50. The method of claim 42, wherein the at least one filter includes a sensitive content filter.

51. The method of claim 42, wherein the at least one filter is applied according to location information for the forum-searching user.

52. The method of claim 51, wherein the location information for the forum-searching user is determined by an IP address associated with the forum-searching user.

53. A processor-implemented method for determining forum post relevancy for a plurality of forum posts, comprising:
receiving forum post data from a forum record in a searchable database for each of a plurality of forum posts;
generating a size metric for each forum post based on an analysis of associated forum post data, wherein the size metric corresponds to the size of the forum post;
generating a post response metric for each forum post based on an analysis of associated forum post data, wherein the post response metric corresponds to the number of responses to the forum post (indirect direct);
generating a post quality metric for each forum post, wherein the post quality metric is based on an analysis of responses to the forum post;
generating a user feedback metric for each forum post, wherein the post feedback metric is based on user feedback to the post;
determining a relevancy rating for each forum post of the plurality of forum posts, wherein the relevancy rating for each forum post is based on the size metric, post response metric, post quality metric and user feedback metric corresponding to the forum post; and
associating the determined relevancy rating for each forum post with the corresponding post data in the forum record, wherein the relevancy rating is an indicator of relevance of the associated post in the forum record.

54. The method of claim 53, wherein the determined relevancy rating for a group of forum posts determines the ordering of the forum posts to be presented to a user, wherein the group of forum posts was selected from the forum record in response to a query generated from user supplied search terms.
